(19) United States
(12) Patent Application Publication
(10) Pub. No.: US 2018/0225595 A1
(43) Pub. Date: Aug. 9, 2018

(54) TRAVEL SUBSCRIPTION DEVICES AND METHODS

(71) Applicants: Abdulaziz ZAKRI, Perrysburg, OH (US); Eyad Yahya Makki ALZAKRI, South Riding, VA (US)

(72) Inventors: Abdulaziz ZAKRI, Perrysburg, OH (US); Eyad Yahya Makki ALZAKRI, South Riding, VA (US)

(21) Appl. No.: 15/424,371

(22) Filed: Feb. 3, 2017

(51) Int. Cl. G06Q 10/02; G06F 17/30; G06Q 20/10

(52) U.S. Cl. CPC G06Q 10/02; G06Q 50/12; G06Q 20/102; G06F 17/30339

(57) ABSTRACT

A travel service transaction system includes a first computing kiosk connected to a first subscription server, a second computing kiosk connected to a second subscription server, and a travel service transaction system server having processing circuitry. The processing circuitry is configured to receive travel data at a travel database center, receive an inquiry to offer a travel service transaction according to terms of a subscriber profile, cross-reference travel criteria of the inquiry with travel data from a requested transaction profile, transfer accepted tell is of the travel service transaction to the subscription server associated with the subscriber profile, deliver a travel service transaction ticket to the first computing kiosk, transfer payment for the travel service transaction ticket from the first computing kiosk to the second computing kiosk, and transfer an enhanced data packet having processing instructions from a first subscription engine to a second subscription engine.

### GRANT OF NON-EXCLUSIVE RIGHT

This application was prepared with financial support from the Saudi Arabian Cultural Mission, and in consideration therefore the present inventor(s) has granted The Kingdom of Saudi Arabia a non-exclusive right to practice the present invention in the United States.

### BACKGROUND

Modern times have seen a dramatic increase in travel, especially air travel. The ease and economic feasibility of making reservations and purchasing tickets, via the Internet has been a major factor in the increase in travel. However, there are still some major drawbacks associated with travel.

One disadvantage associated with travel, especially air travel, is dealing with non-refundable tickets or reservations when plans need to be changed. A change in plans can lead to a loss of a deposit, significant fees in changing travel tickets or reservations, or a loss of the entire travel purchase.

Another disadvantage associated with travel is obtaining an airline ticket or a reservation for a motel/hotel or rental vehicle close to the intended travel date. This usually entails paying a much higher price compared to purchasing the airline ticket or making the reservation weeks before the travel date. An alternative to paying an inflated airline ticket price is waiting at an airport in hopes of obtaining a standby ticket purchase. However, this could entail waiting for several hours and still possibly not being able to obtain an airline ticket for the desired flight.

Flight insurance is provided as a way to refund an airline ticket. However, there are usually numerous restrictions concerning the time of cancelation and the reason for cancelation. In many instances, a ticket ownerneeds to provide documented evidence for the reason of cancelation, such as an illness, a natural disaster, death of an immediate family member, or a terrorist attack.

The “background” description provided herein is for the purpose of generally presenting the context of the disclosure. Work of the presently named inventors, to the extent it is described in this background section, as well as aspects of the description which may not otherwise qualify as conventional at the time of filing, are neither expressly nor impliedly admitted as conventional against the present disclosure.

### SUMMARY

One embodiment includes a travel service transaction system having a first computing kiosk connected to a first subscription server, a second computing kiosk connected to a second subscription server, and a travel service transaction system server having processing circuitry. The processing circuitry is configured to receive travel data at a travel database center, wherein a) the travel data is sorted and indexed into a plurality of database tables including at least one first subscriber profile database table, at least one second subscriber profile database table, at least one available transaction profile database table, and at least one requested transaction profile database table, b) one or more indexed entries of the requested transaction profile database table is cross-referenced to one or more respective indexed entries of the first subscriber profile database table, and c) one or more indexed entries of the available transaction profile database table is cross-referenced to one or more respective indexed entries of the second subscriber profile database table. The processing circuitry is also configured to receive a first inquiry from a first computing device to offer a first travel service transaction according to terms of a first subscriber profile of the first subscriber profile database table, cross-reference travel criteria of the first inquiry with travel data from a requested transaction profile of the requested transaction profile database table, transfer accepted terms of the first travel service transaction to the first subscription server associated with the first subscriber profile from the second subscription server associated with the requested transaction profile, deliver a first travel service transaction ticket to the first computing kiosk associated with the first subscriber profile, and transfer payment for the first travel service transaction ticket from the first computing kiosk associated with the first subscriber profile to the second computing kiosk associated with the requested transaction profile.

The foregoing paragraphs have been provided by way of general introduction, and are not intended to limit the scope of the following claims. The described embodiments, together with further advantages, ill be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an overview of a travel service transfer system according to one embodiment;

FIG. 2 illustrates a computing device view of travel service transfer system according to one embodiment;

FIG. 3 illustrates a system view of travel service transfer system according to one embodiment;

FIG. 4 is a block diagram illustrating an exemplary travel database center according to one embodiment;

FIG. 5 is a block diagram of an exemplary travel web portal according to one embodiment;

FIG. 6 is a workflow diagram for a travel subscription method according to one embodiment;

FIG. 7 illustrates an exemplary progression for a first travel service interface of a travel service transaction application according to one embodiment;

FIG. 8 illustrates an exemplary progression for a second travel service interface of a travel service transaction application according to one embodiment;

FIG. 9 is a block diagram of an exemplary computing system according to one embodiment;

FIG. 10 is a schematic diagram of an exemplary data processing system according to one embodiment;

FIG. 11 is a block diagram of an exemplary CPU according to one embodiment;

FIG. 12 is a flowchart for an exemplary travel subscription method according to one embodiment;

FIG. 13 is an exemplary algorithm for a travel service transaction according to one embodiment;

FIG. 14 is a block diagram illustrating another embodiment of the travel database center according to one embodiment;

FIG. 15 is a block diagram illustrating an exemplary resource management system according to one embodiment; and

FIG. 16 is a flowchart for a travel subscription method according to one embodiment.

### DETAILED DESCRIPTION

The following descriptions are meant to further clarify the present disclosure by giving specific examples and embodiments of the disclosure. These embodiments are meant to be illustrative rather than exhaustive. The full scope of the disclosure is not limited to any particular embodiment disclosed in this specification, but rather is defined by the claims.

In the interest of clarity, not all of the features of the implementations described herein are shown and described in detail. It will be appreciated that in the development of any such actual implementation, numerous implementation-specific decisions need to be made in order to achieve the developer's specific goals, such as compliance with application- and business-related constraints, and that these specific goals will vary from one implementation to another and from one developer to another.

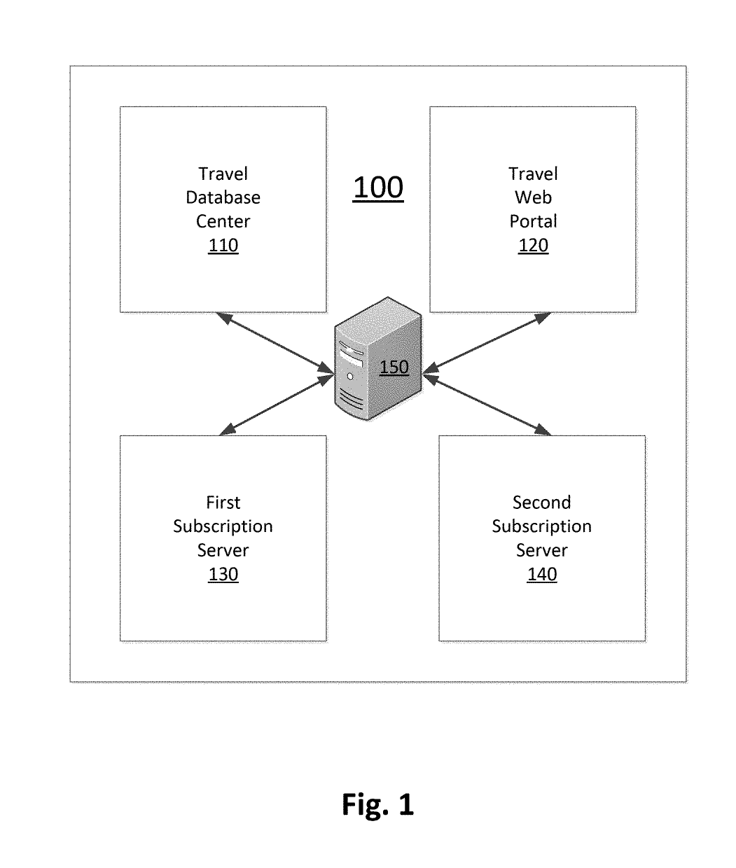

Embodiments herein describe systems and methods for transferring a right to a travel service from one entity to another entity efficiently and securely. FIG. 1 is an overview of a travel service transfer system 100, which includes a travel database center 110, a travel web portal 120, a first subscription server 130, and a second subscription server 140, all of which are interconnected by a system server 150.

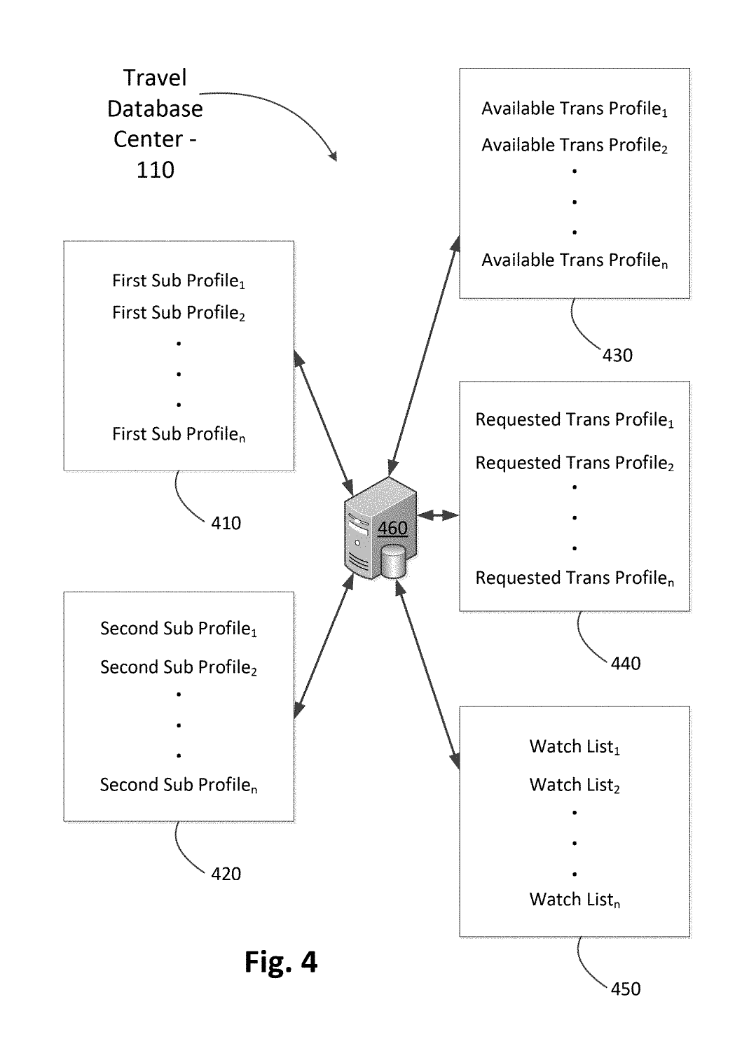

The travel database center 110 includes up-to-date information about travel services available and travel services desired, such as airline tickets, motel/hotel accommodations, and vehicle rentals. A detailed description of travel database center 110 is given herein with reference to FIG. 4.

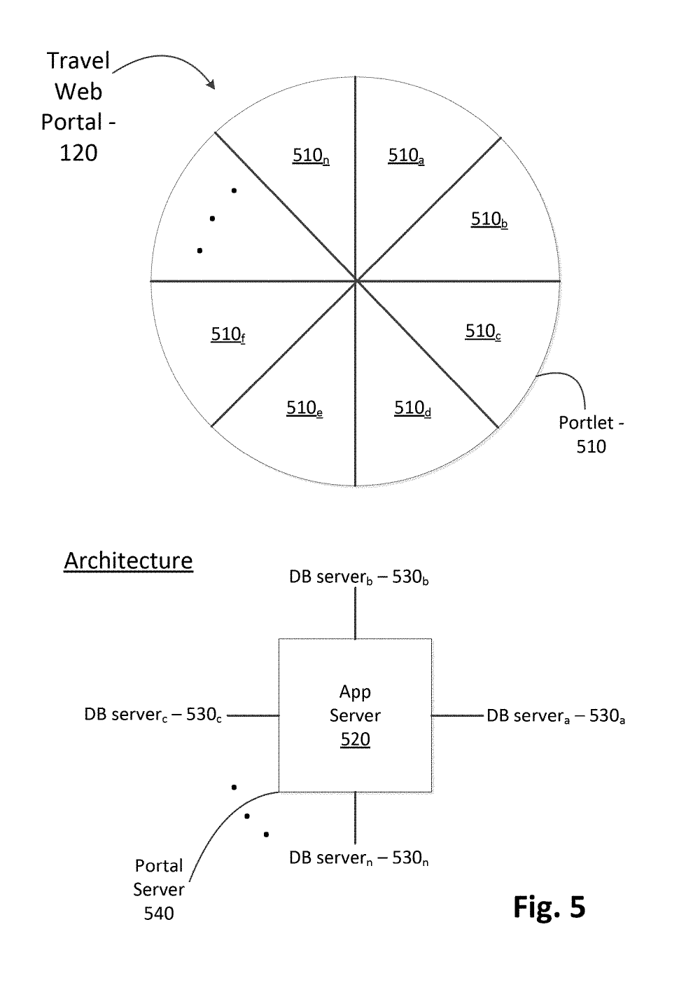

The travel web portal 120 is an interface between different components of the travel service transfer system 100. A detailed description of travel web portal 120 is given herein with reference to FIG. 5.

The first subscription server 130 and the second subscription server 140 are configured with processing circuitry for exchange of travel services between entities. In one example, the first subscription server 130 executes functions for the posting and sale of a travel service by a first entity, while the second subscription server 140 executes functions for the purchase of the travel service by a second entity. However, the first subscription server 130 can execute functions for the purchase of a travel service by a first entity, while the second subscription server 140 can execute functions for the posting and sale of a travel service by the second entity.

Embodiments herein describe a system in which the system server 150 is controlled by a travel-oriented entity. In one embodiment, travel service transfer system 100 provides a system in which an airline ticket can be posted by a first subscriber at the first subscription server 130 and be purchased by a second subscriber at the second subscription server 140 under the auspices of a commercial airline company, via the system server 150. Security is maintained since the complete transaction is controlled by the issuing entity from an initial purchase to a transferred final purchase.

In another embodiment, travel service transfer system 100 provides a system in which a motel/hotel reservation can be posted by a first subscriber at the first subscription server 130 and be purchased by a second subscriber at the second subscription server 140 under the auspices of a motel/hotel company, via the system server 150.

In a another embodiment, travel service transfer system 100 provides a system in which a rental vehicle reservation can be posted by a first subscriber at the first subscription server 130 and be purchased by a second subscriber at the second subscription server 140 under the auspices of a rental vehicle company, via the system server 150.

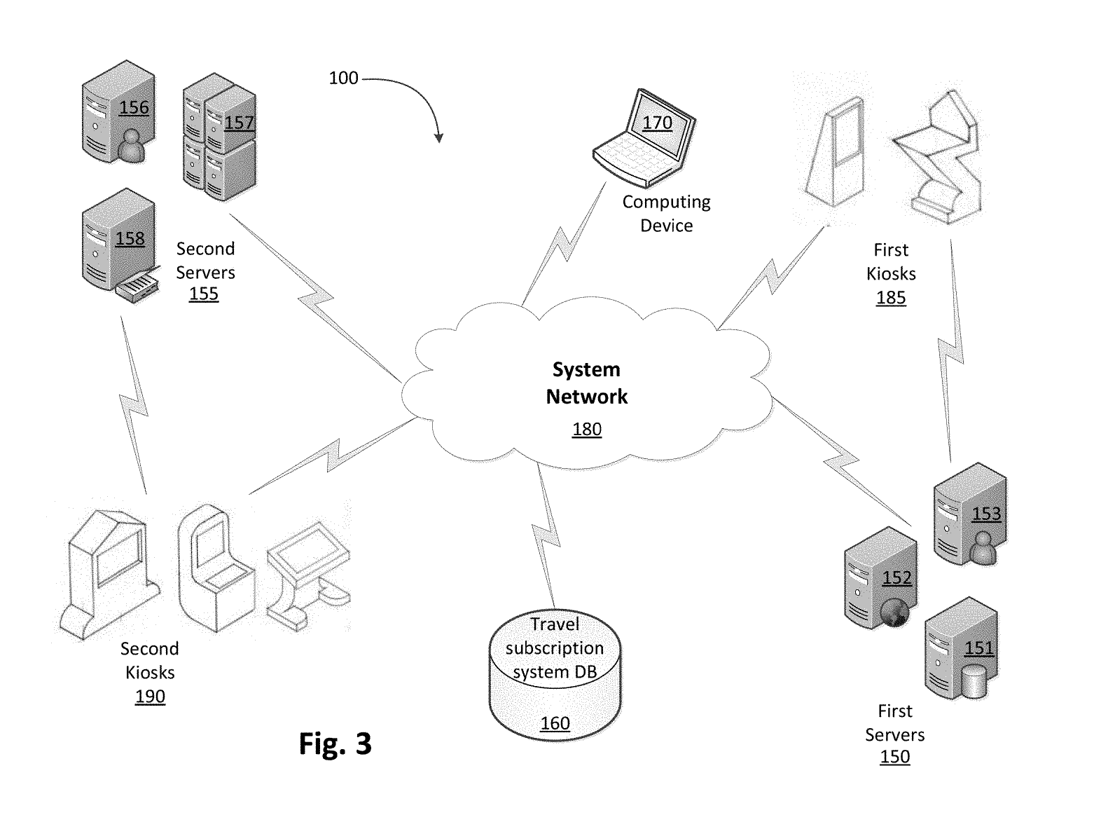

A more detailed description of the travel service transfer system 100 is illustrated in FIG. 3.

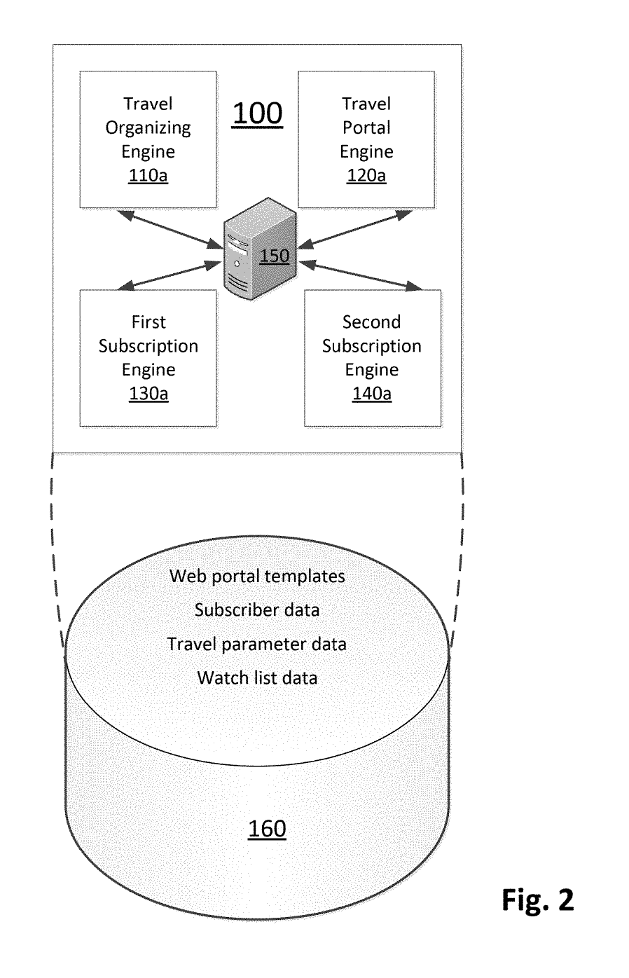

FIG. 2 illustrates a computing device view of travel service transfer system 100. The travel service transfer system 100 includes one or more engines or modules that perform processes associated with retrieving and organizing data from multiple travel service transactions, recipient or buyer profiles, renderer or seller profiles, and security parameters. References to the engines or modules throughout the disclosure are meant to refer to software processes executed by circuitry of one or more processing circuits, which can also be referred to interchangeably as processing circuitry.

A travel organizing engine 110a sorts and organizes travel data received at the travel database center 110. Travel data includes, but is not limited to data from each travel service transaction such as the date, time, and place(s) of each transaction, the profile of each prospective buyer and seller of a travel service transaction, contract terms, and security requirements. Travel data can be received from travel service buyers, travel service sellers, travel agencies, travel service providers, and security government agencies, via system server 150.

A travel portal engine 120a organizes the information sources that are represented by the travel web portal 120. Information sources include, but are not limited to travel agencies, travel service providers, and security government agencies. Travel portal engine 120a formats each information source into a uniform format for display via one or more user interface screens and controls access to other components of the travel service transfer system 100, via system server 150.

A first subscription engine 130a receives and organizes data to and from a first subscriber, such as a seller. User information and preferences are received, along with data for an available travel service transaction, such as an airline ticket, a motel/hotel reservation, or a vehicle rental transaction. A travel service offer can be received at the first subscription engine 130a and transferred to the travel organizing engine 110a and/or the travel portal engine 120a, via system server 150.

A second subscription engine 140a receives and organizes data to and from a second subscriber, such as a buyer. User information and preferences are received, along with data for a desired travel service transaction, such as an airline ticket, a motel/hotel reservation, or a rental vehicle transaction. A travel service request can be received at the second subscription engine 140a and transferred to the travel organizing engine 110a, the travel portal engine 120a, and/or the first subscription engine 130a, via system server 150.

In one example, the first subscription engine 130a executes functions for the sale of a travel service by a first entity and the second subscription engine 140a executes functions for the purchase of the travel service by a second entity. However, the first subscription engine 130a can execute functions for the purchase of a travel service by a first entity and the second subscription engine 140a can execute functions for the sale of a travel service by the second entity.

Each of the travel organizing engine 110a, the travel portal engine 120a, the first subscription engine 130a, and the second subscription engine 140a transmit data to and from a travel service transfer system database 160. Travel service transfer system database 160 includes, but is not limited to web portal templates from the travel web portal 120, travel data from the travel database center 110, request data from the travel web portal 120, subscriber data to and from the first subscription server 130 and the second subscription server 140, and watch list data from security and/or government agencies. Data transfer is implemented, via system server 150.

FIG. 3 illustrates a system view of travel service transfer system 100. First servers 150 include, but are not limited to a database server 151, a web server 152, and a real-time server 153 or other servers in which to implement executions associated with the first subscription server 130. The database server 151 can be used in conjunction with the travel database center 110, the web server 152 can be used in conjunction with the travel web portal 120, and the real-time server 153 can be used with the second subscription server 140.

Second servers 155 include, but are not limited to a real-time server 156, an application server 157, and a directory server 158, or other servers in which to implement executions associated with the second subscription server 140. The real-time server 156 can be used with the first subscription server 130, the application server 157 can be used in conjunction with the travel database center 110 and the travel web portal 120, and the directory server 158 can be used in conjunction with the travel web portal 120.

The travel service transfer system database 160 includes, but is not limited to web portal templates from the travel web portal 120, travel data from the travel database center 110, request data from the travel web portal 120, subscriber data to and from the first subscription server 130 and the second subscription server 140, and watch list data from security and/or government agencies, via the travel web portal 120.

First kiosks 185 include interactive computing modules which house a computer terminal and associated kiosk software. Each of the first kiosks 185 is configured to receive input from a user and display retrieved results to the user. For example, a user can input a search request for a particular airline flight. Results of the search request for the airline flight are displayed on a display screen of the associated kiosk. In an embodiment, a printer can be associated with one or more of the first kiosks 185 to print search results or a transaction confirmation. Computerized kiosks can store data locally or retrieve it from a computer network. Touchscreens, trackballs, computer keyboards, and pushbuttons can be used as input devices for an interactive computer kiosk. Touchscreen kiosks can be used as industrial appliances to reduce lines, eliminate paper, and improve efficiency and service. First kiosks 185 can be used in association with first servers 150.

Second kiosks 190 include interactive computing modules which house a computer terminal and associated kiosk software. Each of the second kiosks 190 is configured to receive input from a user and display retrieved results to the user. For example, a user can input a request to purchase a particular airline flight ticket. Results of the request for the particular airline flight ticket are displayed on a display screen of the associated kiosk, which can include input fields for completing a transaction for the particular airline flight ticket. In an embodiment, a printer can be associated with one or more of the second kiosks 190 to print a purchased airline flight ticket. Computerized kiosks can store data locally or retrieve it from a computer network. Touchscreens, trackballs, computer keyboards, and pushbuttons can be used as input devices for an interactive computer kiosk. Touchscreen kiosks can be used as industrial appliances to reduce lines, eliminate paper, and improve efficiency and service. Second kiosks 190 can be used in association with second servers 155.

One or more computing devices 170 execute communications between different components of the travel service transfer system 100, via a system network 180. Each of the one or more computing devices 170 is configured to receive input from a user and display retrieved results to the user. For example, each of the one or more computing devices 170 is configured to receive input from a user, such as a search request or a purchase of a travel service. Results of the search request or purchase are displayed on a display screen of the associated computing device 170. System network 180 includes, but is not limited to wired and wireless networks, cloud networks, the Internet, intranets, extranets, wide-area networks (WANs), and local-area networks (LANs). System network 180 provides communication between each of the first servers 150, the second servers 155, the travel subscription system database 160, computing devices 170, the first kiosks 185, and the second kiosks 190.

Travel service transfer system 100 includes various devices with processing circuitry for executing functions of each of the travel database center 110, the travel web portal 120, the first subscription server 130, and the second subscription server 140, as well as integration of each component with one or more other components of the travel service transfer system 100. In one embodiment, special purpose processing circuitry is configured to receive a travel service request, such as an airline ticket from a computing device associated with a user, and match data from the travel service request with existing data from an available travel service transaction in travel database center 110. A source for a matching travel service transaction, such as an airlines subscriber is located, via the travel web portal 120. Special purpose processing circuitry exists throughout the travel service transfer system 100 and is responsible for execution of numerous functions therein.

FIG. 4 is a block diagram illustrating travel database center 110, which includes a database table for first subscriber profiles 410, which includes pertinent profile data for a registered subscriber, such as an intended seller of a travel service transaction. First subscriber profiles 410 include, but are not limited to identity information such as the name, address, date of birth, and other identifying information associated with a registered subscriber. First subscriber profiles 410 can also include data of interest to the associated user, such as a travel service transaction that is available for sale. For an available airline ticket, data of interest can include the date, time, and locations pertinent to an available airline ticket.

FIG. 4 also illustrates a database table for second subscriber profiles 420, which includes pertinent profile data for a registered subscriber, such as an intended purchaser of a travel service transaction. Second subscriber profiles 420 include, but are not limited to identity information such as the name, address, date of birth, and other identifying information associated with a registered subscriber. Second subscriber profiles 420 can also include data of interest to the associated user, such as a desired travel service transaction. For a desired airline ticket, data of interest can include the date, time, and locations pertinent to the desired airline ticket.

The travel database center 110 of FIG. 4 also illustrates a database table for available transaction profiles 430. Each available transaction profile 430 includes data pertinent to an associated travel service transaction that is available, such as an airline ticket, a motel/hotel reservation, or a rental vehicle transaction. Pertinent data includes, but is not limited to the date, time, and location(s) of the travel service transaction, as well as any restrictions or requirements of the travel service transaction. A database server 460 cross-references the criteria of each travel service transaction in the database table of available transaction profiles 430 to the database of all applicable second subscriber profiles 420 in which one or more types of travel transactions are desired. In the example given herein, the database table of second subscriber profiles 420 is associated with users interested in obtaining one or more travel service transactions.

The travel database center 110 of FIG. 4 also illustrates a database table for requested transaction profiles 440. Each requested transaction profile 440 includes data pertinent to an associated travel service transaction that is requested by a user, such as an airline ticket, motel/hotel reservation, or rental vehicle transaction. Pertinent data includes, but is not limited to the date, time, and location(s) of the travel service transaction, as well as any restrictions or requirements of the travel service transaction. The database server 460 cross-references criteria of each travel service transaction in the database table of requested transaction profiles 440 to the database of all applicable first subscriber profiles 410 in which one or more types of travel transactions are available. In the example given herein, the database table of first subscriber profiles 410 is associated with users interested in selling one or more travel service transactions associated with travel reservations currently held by the users who are interested in selling the one or more travel service transactions.

Travel database center 110 in FIG. 4 also illustrates a database table of watch lists 450. Watch lists can include a comprehensive list or links to local, national, and international agencies to include individuals wanted for criminal activity, outstanding warrants, or suspected terrorist activity. The database table of watch lists 450 can also include positive watch lists 450, such as frequent flyer award recipients, persons-of-interest, or famous actors, athletes, or politicians visiting the area.

FIG. 4 is described herein as including first subscription profiles 410 directed to registered users interested in selling one or more travel service transactions being held by respective registered subscribers. The requested travel service transaction profiles 440 include data for a plurality of travel service transactions that are wanted or desired by others. In an example, this is analogous to a “wanted” electronic bulletin board. Therefore, data from the requested transaction profiles 440 are correlated with data from the first subscriber profiles 410. However, in an alternative embodiment, the first subscription profiles 410 can include data directed to registered users interested in obtaining one or more travel service transactions. In the alternative embodiment, data from the available travel service transaction profiles 430 would be correlated with data from the first subscription profiles 410.

Likewise, FIG. 4 is described herein as including second subscription profiles 420 directed to registered users interested in obtaining one or more travel service transactions. The available travel service transaction profiles 430 include data for a plurality of travel service transactions that are available by others. Therefore, data from the available transaction profiles 430 are correlated with data from the second subscriber profiles 420. However, in an alternative embodiment, the second subscription profiles 420 can include data directed to registered subscribers interested in selling one or more travel service transactions. In the alternative embodiment, data from the requested travel service transaction profiles 440 would be correlated with data from the second subscription profiles 420.

Embodiments herein also include a first subscriber profile and a second subscriber profile directed to the same individual or registered user. In one example, a registered user may desire to sell an airline ticket to a first destination and purchase an airline ticket to a second destination. In a second example, a registered user may desire to sell a motel/hotel reservation for a first period of time and purchase a motel/hotel reservation for a second period of time.

FIG. 4 illustrates the effective and efficient correlation of a large spectrum of subscribers with a large spectrum of travel service transactions by database server 460. The registration records of subscriber profiles can be kept up-to-date with current data. In addition, each prospective transaction can be checked against one or more watch lists 450 to ensure safety of each transaction and subsequent travel by an individual.

FIG. 5 is a block diagram of an exemplary travel web portal 120 according to embodiments described herein. A web portal is a specially-designed web site that brings information together from diverse information sources to display in a uniform format. A user is presented a uniform web page interface that brings together content from a number of other systems or servers. In some implementations, information related to travel requests and inquiries, as well as travel data can be input at the web portal interfaces.

Each information source can have a dedicated display region, called a portlet 510. The portlet 510 can depend on the intended user, the intended purpose, implementation framework, and/or code libraries, for example. Travel web portal 120 can include multiple portlets 510ₐ-510ₙ, wherein each portlet 510 can be a dedicated area for each information source. Travel web portal 120 can use a search engine application programming interface (API) to permit users to search via an intranet, as well as extranet content.

Travel web portal 120 can include portlets 510 for individual airlines, travel agencies, motel/hotel companies, rental vehicle companies, and government agencies. Travel web portal 120 can also include multiple layers of portlets 510. In one example, an airlines primary portlet can be subdivided into multiple sub-portlets according to individual airline companies. Likewise, a travel agency primary portlet can be subdivided into multiple sub-portlets according to individual travel agencies, a motel/hotel primary portlet can be subdivided into multiple sub-portlets according to individual travel agencies, and a rental vehicle primary portlet can be subdivided into multiple sub-portlets according to individual rental vehicle companies. In another example, a government primary portlet can be subdivided into one or more local, national, and international agencies.

The architecture of travel web portal 120 is also illustrated in FIG. 5. An application server 520 performs most of the functions of the travel web portal 120. In one embodiment, authorized and authenticated subscribers can generate requests to application server 520.

Application server 520 is connected to one or more database servers 530, such as database servers 530ₐ-530ₙ to form a travel service network. The travel service network is associated with the travel data tables 410, 420, 430, 440, and 450 of the travel database center 110. Each database server 530ₐ-530ₙ transmits and receives travel data to and from a respective portlet 510 of the travel web portal 120. In an embodiment, application server 520 can be part of a clustered server environment. High-capacity portal configurations can include load balancing strategies for the clustered server environment.

A portal server 540 hosts the travel web portal 120 and provides connectivity to the application server 520. In an embodiment, the portal server 540 is a pass-through for a subscriber. Application functionality can be presented in any number of portal pages via the portlets 510.

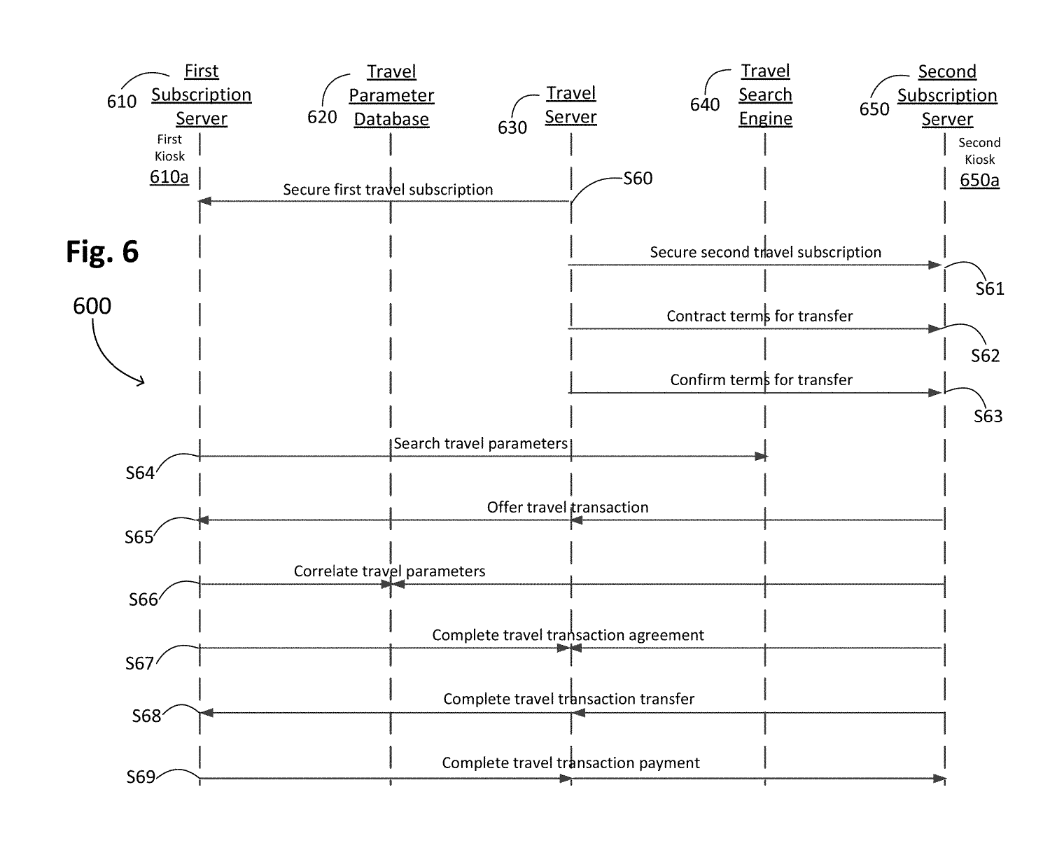

FIG. 6 is a workflow diagram for a travel subscription method 600. Entities within the travel subscription method 600 include a first subscription server 610, a travel parameter database 620, a travel server 630, a travel search engine 640, and a second subscription server 650. A first kiosk 610a is associated with the first subscription server 610, and a second kiosk 650a is associated with the second subscription server 650.

In step S60, a first travel subscription is secured with the first subscription server 610, via the travel server 630. In one embodiment, the first travel subscription is secured through the first kiosk 610a or other computing device associated with the first subscription server 610.

In step S61, a second travel subscription is secured with the second subscription server 650, via the travel server 630. In one embodiment, the second travel subscription is secured through the second kiosk 650a or other computing device associated with the second subscription server 650.

In step S62, terms for a transfer of a travel transaction is contracted with the second subscription server 650, via the travel server 630. Examples of a travel transaction include, but are not limited to an airline ticket, a motel/hotel reservation, and a rental vehicle reservation. In one embodiment, terms for a transfer of a travel transaction include terms for resale of an airline ticket, motel/hotel reservation, or a rental vehicle reservation.

In step S63, terms for the transfer of the travel transaction with the second subscription server 650 are confirmed, via the travel server 630. Tell is include, but are not limited to date, time, location(s), price, and method of payment of the travel transaction.

In step S64, one or more travel parameters queried by the first subscription server 610 are searched, via the travel search engine 640. The queried travel parameters can be searched at the first kiosk 610a or other computing device associated with the first subscription server 610.

In step S65, the travel transaction is offered by the second subscription server 650 to the first subscription server 610, via the travel server 630. In one embodiment, the travel transaction is offered by the second subscription server 650 for resale to the first subscription server 610.

In step S66, the one or more travel parameters of the travel transaction requested by the first subscription server 610 are correlated with respective one or more travel parameters offered by the second subscription server 650, via the travel parameter database 620. The travel parameters of the travel transaction match at least in part, the one or more travel parameters queried by the first subscription server 610 in step S64.

In step S67, a travel transaction agreement between the first subscription server 610 and the second subscription server 650 for the travel transaction is completed, via the travel server 630. The travel transaction agreement can include, but is not limited to price and payment conditions.

In step S68, a transfer of the travel transaction from the second subscription server 650 to the first subscription server 610 for the travel transaction is completed, via the travel server 630. The transfer includes rights of the travel transaction from the second subscription server 650 to the first subscription server 610.

In step S69, payment for the travel transaction is made from the first subscription server 610 to the second subscription server 650. Payment for the travel transaction can include payment of monetary funds or a voucher for future travel services.

In one embodiment, the first subscription server 610 differs from the second subscription server 650 in travel subscription method 600. Respective first kiosk 610a and second kiosk 650a also differ from one another. This embodiment could be implemented for a first user in a first location different from a second user in a second location.

In a second embodiment, the first subscription server 610 is the same as the second subscription server 650. This embodiment could be implemented for a single location that is used by a plurality of subscribers. For example, the first subscription server 610 can secure one or more travel subscription purchase agreements and one or more travel subscription sales agreements. Likewise, the second subscription server 650 can secure one or more travel subscription purchase agreements and one or more travel subscription sales agreements.

In one embodiment, the travel server 630 operates within a commercial airlines website and the travel transaction includes a non-refundable airline ticket. Likewise, the travel server 630 can operate within a travel agency website and the travel transaction can include one or more of a non-refundable airline ticket, a motel/hotel reservation, or a rental vehicle reservation.

In one embodiment, the travel subscription sales agreement includes a real-time graduated fee schedule based upon an original purchase price of the travel transaction. Transaction parameters can include one or more of a ticket holder identity, travel itinerary, and financial payment arrangements.

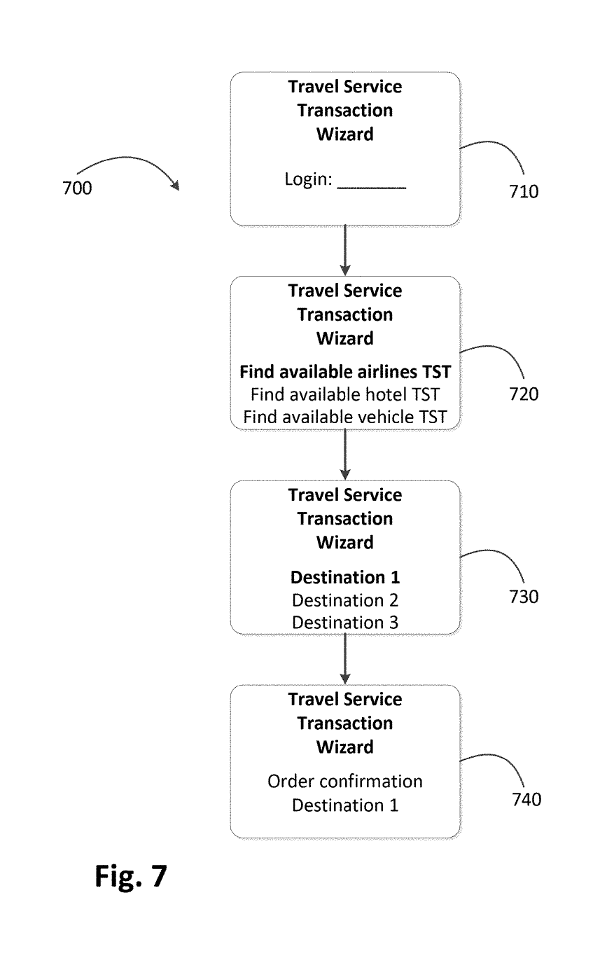

FIG. 7 illustrates an exemplary progression for a first travel service interface 700 for a travel service transaction application as described by embodiments herein. Travel service interface 700 can be used with a kiosk, computing device, or mobile device associated with a subscription server.

FIG. 7 illustrates an embodiment n which a user is interested in obtaining a travel service transaction. After accessing an established web site of the travel service system 100, a first image is displayed, such as image 710 in which a subscriber is requested to login. An option can also be displayed for a new subscriber to register.

After login information is received and subscriber profile preferences have been retrieved, multiple travel service transactions are searched, via the travel search engine 640. The resulting choices are displayed in image 720, such as find an available airlines travel service transaction (TST), find an available motel/hotel TST, and find an available rental vehicle TST. In image 720, the first option to find an available airline TST is selected.

Image 730 illustrates multiple identified airline TSTs that are correlated with the subscriber profile preferences and other inputted search parameters. An example subscriber profile preference can include the subscriber's home base. As a result, initial results can include TSTs from the subscriber's home base. However, other search parameters can be inputted if another location is desired. Only three airline TSTs are illustrated in image 730 for simplicity. However, several more results may be displayed, depending upon the inputted search parameters. Results can be displayed according to user profile parameters. In image 730, the first option for Destination 1 is selected.

In image 730, an option can be available to obtain information regarding each selection. For example, a right click upon a particular selection leads to a description of that selection. When an airline's TST has been selected, flight information for each airline's TST selection can be obtained by right-clicking on a selection. When a motel/hotel TST has been selected, hotel name, location, and room description can be obtained by right-clicking on a selection. When a rental vehicle TST has been selected, the make and model of available cars can be obtained by right-clicking on a selection.

Image 740 illustrates an order confirmation in which Destination 1 was selected. FIG. 7 is given for illustrative purposes only. Other travel service interfaces for a kiosk, computing device, or mobile device are contemplated by embodiments described herein. In one embodiment, a printer can be connected to a kiosk to print the purchased travel service transaction ticket for the travel service transaction illustrated in FIG. 7.

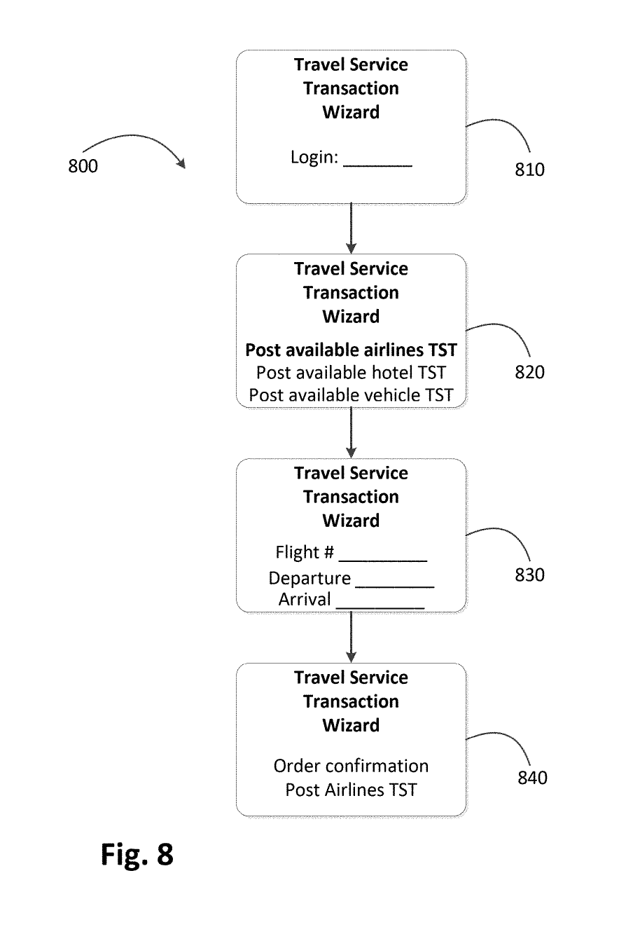

FIG. 8 illustrates an exemplary progression for a second travel service interface 800 for a travel service transaction application as described by embodiments herein. Travel service interface 800 can be used with a kiosk, computing device, or mobile device associated with a subscription server.

FIG. 8 illustrates an embodiment in which a user is interested in offering a TST for resale. After surfing to an established web site of the travel service system 100, a first image is displayed, such as image 810 in which a subscriber is requested to login. An option can also be displayed for a new subscriber to register.

After login info nation is received, multiple choices are displayed in image 820, such as post an available airline TST, post an available motel/hotel TST, and post an available rental vehicle TST. In image 820, the first option to post an available airline TST is selected.

In image 830, a query is displayed in which one or more identifying parameters are requested. For an airline TST posting, a request for the flight number can be displayed. When the flight number is entered, associated information can be automatically populated, such as the ticket holder's identification information and the flight information. When the information associated with the requested parameters has been provided, either manually or automatically, a review and confirmation of the information is requested.

Image 840 illustrates an order confirmation in which a particular airline TST was selected. The particular flight number and identifying flight information can be displayed for review by the subscriber. The subscriber is requested to confirm the posting of the airline TST.

FIG. 8 is given for illustrative purposes only. Other travel service interfaces for a kiosk, computing device, or mobile device are contemplated by embodiments described herein.

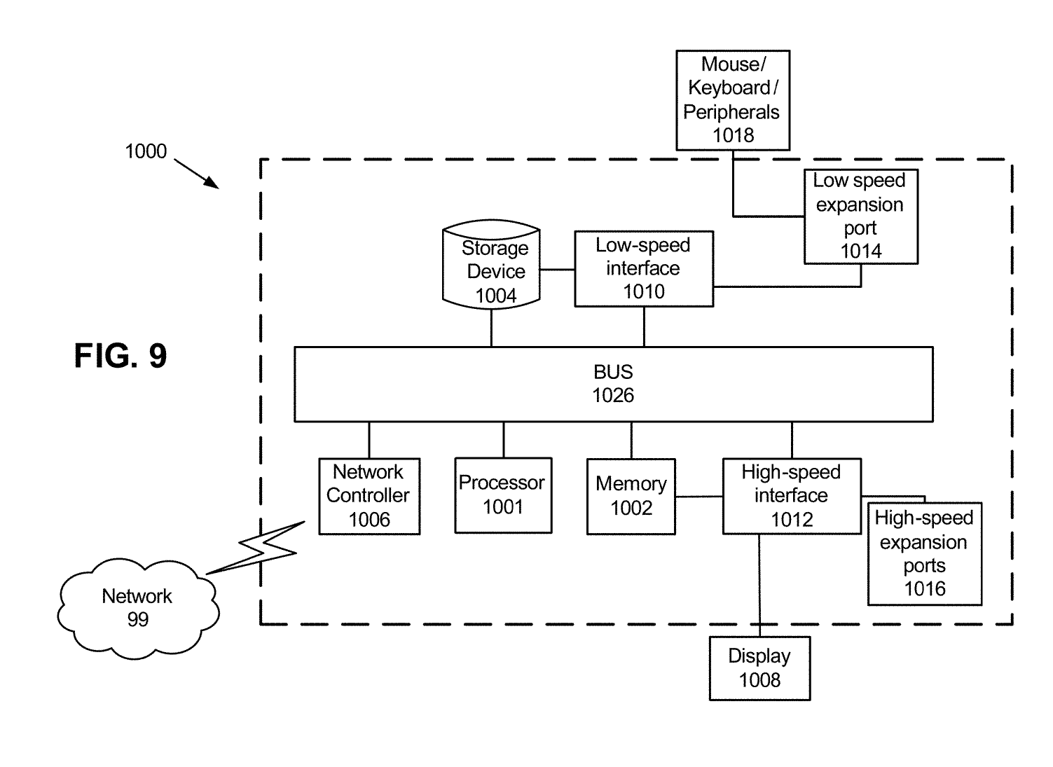

A hardware description of an exemplary computing device 1000 used in accordance with embodiments herein is described with reference to FIG. 9. Computing device 1000 can be used as one or more of the devices illustrated in user transactions to and from the travel database center 110 via the travel organizing engine 110a, the travel web portal 120 via the travel portal engine 120a, the first subscription server 130 via the first subscription engine 130a, and the second subscription server 140 via the second subscription engine 140a, along with the system server 150 illustrated in FIGS. 1-2.

Computing device 100 can also be used as any one of the first servers 150, the second servers 155, the computing device 170, the first kiosks 185, and the second kiosks 190 illustrated in FIG. 3, which can also be referred to as computing devices. Computing device 100 can also be used as any one of database tables 410, 420, 430, 440, and 450, and the database server 460 illustrated in FIG. 4. Computing device 1000 can also be used as the application server 520, the portal server 540, and any one of the database servers 530ₐ-530ₙ of the travel web portal 120 illustrated in FIG. 5.

Computing device 1000 is intended to represent various forms of digital hardware, such as laptops, desktops, workstations, personal digital assistants, servers, blade servers, mainframes, and other appropriate computers. The components shown here, their connections and relationships, and their functions are meant to be examples only and are not meant to be limiting.

The computing device 1000 includes a processor 1001, a memory 1002, a storage device 1004, a high-speed interface 1012 connecting to the memory 1002 and multiple high-speed expansion ports 1016, and a low-speed interface 1010 connecting to a low-speed expansion port 1014 and the storage device 1004. Each of the processor 1001, the memory 1002, the storage device 1004, the high-speed interface 1012, the high-speed expansion ports 1016, and the low-speed interface 1010 are interconnected using various busses, such as communication bus 1026, and may be mounted on a common motherboard or in other manners as appropriate.

The processor 1001 can process instructions for execution within the computing device 1000, including instructions stored in the memory 1002 or on the storage device 1004 to display graphical information for a GUI on an external input/output device, such as a display 1008 coupled to the high-speed interface 1012. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system). The memory 1002 stores information within the computing device 1000. In some implementations, the memory 1002 is a volatile memory unit or units. In some implementations, the memory 1002 is a non-volatile memory unit or units. The memory 1002 can also be another form of computer-readable medium, such as a magnetic or optical disk.

The storage device 1004 is capable of providing mass storage for the computing device 1000. In some implementations, the storage device 1004 can be or contain a computer-readable medium, such as a floppy disk device, a hard disk device, an optical disk device, a tape device, a flash memory or other similar solid state memory device, or an array of devices, including devices in a storage area network or other configurations. Instructions can be stored in an information carrier. The instructions, when executed by one or more processing devices (for example, processor 1001), perform one or more methods, such as those described above. The instructions can also be stored by one or more storage devices, such as computer- or machine-readable mediums (for example, the memory 1002, the storage device 1004, or memory on the processor 1001).

The high-speed interface 1012 manages bandwidth-intensive operations for the computing device 1000, while the low-speed interface 1010 manages lower bandwidth-intensive operations. Such allocation of functions is an example only. In some implementations, the high-speed interface 1012 is coupled to the memory 1002, the display 1008 (e.g., through a graphics processor or accelerator), and to the high-speed expansion ports 1016, which may accept various expansion cards (not shown). In the implementation, the low-speed interface 1010 is coupled to the storage device 1004 and the low-speed expansion port 1014. The low-speed expansion port 1014, which can include various communication ports (e.g., USB, Bluetooth, Ethernet, wireless Ethernet) can be coupled to one or more input/output devices 1018, such as a keyboard, a pointing device, a scanner, or a networking device such as a switch or router, e.g., through a network adapter.

The computing device 1000 also includes a network controller 1006, such as an Intel Ethernet PRO network interface card from Intel Corporation of America, for interfacing with a network 99. As can be appreciated, the network 99 can be a public network, such as the Internet, or a private network such as an LAN or WAN network, or any combination thereof and can also include PSTN or ISDN sub-networks. The network 99 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

Although the computing device 1000 of FIG. 9 is described as having a storage medium device 1004, the claimed advancements are not limited by the form of the computer-readable media on which the instructions of the described processes are stored. For example, the instructions can be stored on CDs, DVDs, in FLASH memory, RAM, ROM, PROM, EPROM, EEPROM, hard disk, or any other information processing device with which the computing device communicates.

In other alternate embodiments, processing features according to the present disclosure may be implemented and commercialized as hardware, a software solution, or a combination thereof. Moreover, instructions corresponding to processes described herein could be stored in a portable drive, such as a USB Flash drive that hosts a secure process.

Computer programs (also known as programs, software, software applications, or code) associated with the processes described herein include machine instructions for a programmable processor, and can be implemented in a high-level procedural and/or object-oriented programming language, and/or in assembly/machine language. As used herein, the terms machine-readable medium and computer-readable medium refer to any computer program product, apparatus, and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described herein can be implemented on a computer having a display device 1008 (e.g., a CRT (cathode ray tube) or LCD (liquid crystal display) monitor) for displaying information to the user and a keyboard and a pointing device 1018 (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback), and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

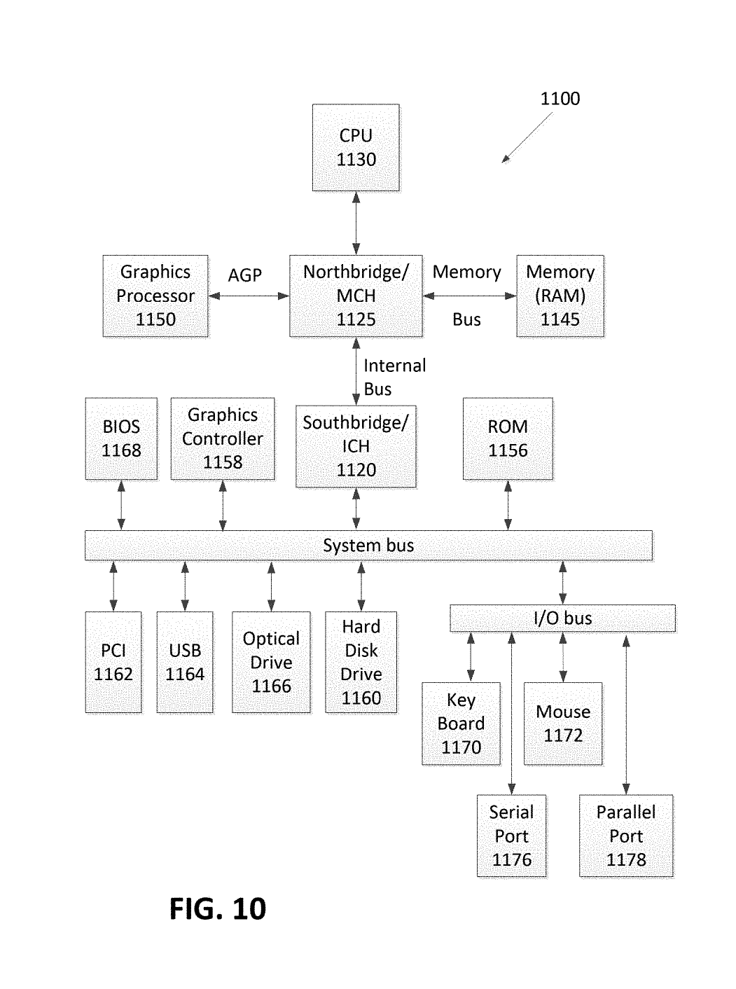

FIG. 10 shows a schematic diagram of an exemplary data processing system, according to aspects of the disclosure described herein for performing menu navigation, as described above. The data processing system is an example of a computer in which code or instructions implementing the processes of the illustrative embodiments can be located.

In FIG. 10, data processing system 1100 employs an application architecture including a north bridge and memory controller hub (NB/MCH) 1125 and a south bridge and input/output (I/O) controller hub (SB/ICH) 1120. The central processing unit (CPU) 1130 is connected to NB/MCH 1125. The NB/MCH 1125 also connects to the memory 1145 via a memory bus, and connects to the graphics processor 1150 via an accelerated graphics port (AGP). The NB/MCH 1125 also connects to the SB/ICH 1120 via an internal bus (e.g., a unified media interface or a direct media interface). The CPU 1130 can contain one or more processors and even can be implemented using one or more heterogeneous processor systems.

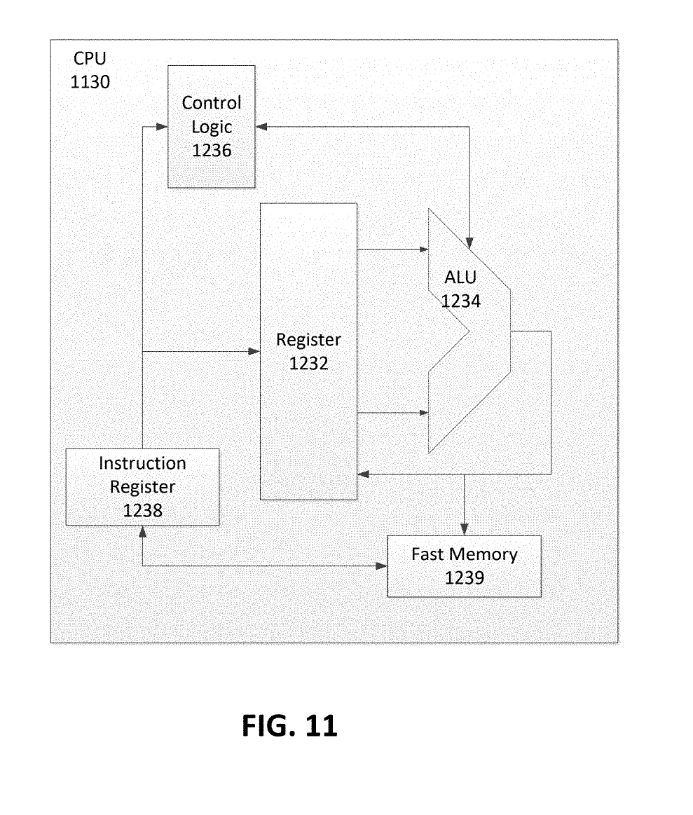

For example, FIG. 11 illustrates one implementation of CPU 1130. In one implementation, an instruction register 1238 retrieves instructions from a fast memory 1239. At least part of these instructions are fetched from an instruction register 1238 by a control logic 1236 and interpreted according to the instruction set architecture of the CPU 1130. Part of the instructions can also be directed to a register 1232. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using an arithmetic logic unit (ALU) 1234 that loads values from the register 1232 and performs logical and mathematical operations on the loaded values according to the instructions. The results from these operations can be fed back into the register 1232 and/or stored in a fast memory 1239. According to aspects of the disclosure, the instruction set architecture of the CPU 1130 can use a reduced instruction set computer (RISC), a complex instruction set computer (CISC), a vector processor architecture, or a very long instruction word (VLIW) architecture. Furthermore, the CPU 1130 can be based on the Von Neuman model or the Harvard model. The CPU 1130 can be a digital signal processor, an FPGA, an ASIC, a PLA, a PLD, or a CPLD. Further, the CPU 1130 can be an ×86 processor by Intel or by AMD; an ARM processor; a Power architecture processor by, e.g., IBM; a SPARC architecture processor by Sun Microsystems or by Oracle; or other known CPU architectures.

Referring again to FIG. 10, the data processing system 1100 can include the SB/ICH 1120 being coupled through a system bus to an I/O Bus, a read only memory (ROM) 1156, universal serial bus (USB) port 1164, a flash binary input/output system (BIOS) 1168, and a graphics controller 1158. PCI/PCIe devices can also be coupled to SB/ICH 1120 through a PCI bus 1162.

The PCI devices can include, for example, Ethernet adapters, add-in cards, and PC cards for notebook computers. The Hard disk drive 1160 and CD-ROM 1166 can use, for example, an integrated drive electronics (IDE) or serial advanced technology attachment (SATA) interface. In one implementation the I/O bus can include a super I/O (SIO) device.

Further, the hard disk drive (HDD) 1160 and optical drive 1166 can also be coupled to the SB/ICH 1120 through a system bus. In one implementation, a keyboard 1170, a mouse 1172, a parallel port 1178, and a serial port 1176 can be connected to the system bus through the I/O bus. Other peripherals and devices can be connected to the SB/ICH 1120 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein can also be executed by various distributed components of a system. For example, one or more processors can execute these system functions, wherein the processors are distributed across multiple components communicating in a network. The distributed components can include one or more client and server machines, which can share processing, such as a cloud computing system, in addition to various human interface and communication devices (e.g., display monitors, smart phones, tablets, personal digital assistants (PDAs)). The network can be a private network, such as a LAN or WAN, or can be a public network, such as the Internet. Input to the system can be received via direct user input and received remotely either in real-time or as a batch process. Additionally, some implementations can be performed on modules or hardware not identical to those described. Accordingly, other implementations are within the scope that can be claimed.

The functions and features described herein may also be executed by various distributed components of a system. For example, one or more processors may execute these system functions, wherein the processors are distributed across multiple components communicating in a network. For example, distributed performance of the processing functions can be realized using grid computing or cloud computing. Many modalities of remote and distributed computing can be referred to under the umbrella of cloud computing, including: software as a service, platform as a service, data as a service, and infrastructure as a service. Cloud computing generally refers to processing performed at centralized locations and accessible to multiple users who interact with the centralized processing locations through individual terminals.

Embodiments described herein can be implemented in conjunction with one or more of the devices described above with reference to FIG. 1. Embodiments are a combination of hardware and software, and processing circuitry by which the software is implemented.

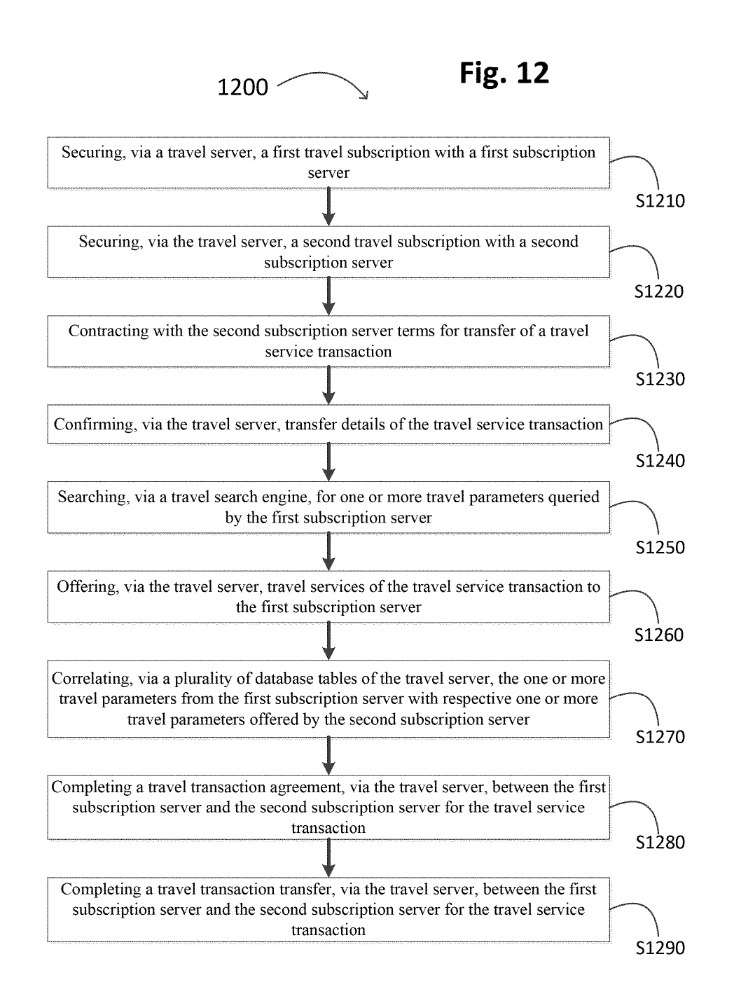

FIG. 12 illustrates an exemplary flowchart for a travel subscription method 1200 according to an aspect of the present disclosure. Method 1200 includes programmable computer-executable instructions, that when used in combination with the above-described hardware devices, carry out the steps of method 1200. The hardware description above, exemplified by any one of the structural examples illustrated in FIGS. 9-11 constitutes or includes specialized corresponding structure that is programmed or configured to perform the algorithm illustrated in FIG. 12. For example, the algorithm illustrated in FIG. 12 can be completely performed by the single device illustrated in FIG. 9 or by the chipset illustrated in FIG. 10.

FIG. 12 is a flowchart for an exemplary travel subscription method 1200. Method 1200 can be implemented using one or more of the computing systems 1000 or 1100 described herein.

In step S1210, a first travel subscription is secured with a first subscription server, via a travel server. In an example, given for illustrative purposes only, the first travel subscription can include terms for a real-time graduated fee schedule purchase price. However, other methods and schedules to determine a purchase price are contemplated by embodiments described herein. The first travel subscription can also include terms for providing identity information as a purchaser of a travel service transaction, such as an airlines reservation, a motel/hotel reservation, or a rental vehicle reservation. The first travel subscription can also include terms for arrangements for securing a guaranteed payment transfer, and an agreement on subscription membership fees.

In step S1220, a second travel subscription is secured with a second subscription server, via a travel server. In an example, given for illustrative purposes only, the second travel subscription can include terms for an agreement to sell a travel service transaction to a qualified purchaser. The second travel subscription can also include a real-time graduated fee schedule sales price. However, other methods and schedules to determine a sales price are contemplated by embodiments described herein. The second travel subscription can also include terms for arrangements for a secure payment receipt, agreement to subscription member fees, and agreement to any associated commission.

In step S1230, terms for transfer of a travel service transaction with the second subscription server is contracted. Terms for transfer include, but are not limited to an agreement to sell a travel service transaction to a qualified purchaser, agreement to a real-time graduated fee schedule sales price, and agreement to any associated commission.

In step S1240, transfer details of the travel transaction are confirmed. Transfer details include, but are not limited to acceptance of all sales agreement terms, acceptance of all purchase agreement terms, and passing all security requirements of the transfer implemented via encryption and/or links to government agencies.

In step S1250, one or more travel service parameters queried by the first subscription server is searched, via a travel search engine. In an embodiment the travel search engine is associated with the travel server.

In step S1260, travel services pertaining to the travel transaction to the first subscription server are offered, via the travel server. An offer is made to the public concerning travel service transactions that are available for purchase, such as airline tickets, motel/hotel reservations, and rental vehicle reservations.

In step S1270, the travel parameters are correlated from the first subscription server with respective one or more travel parameters offered by the second subscription server, via a plurality of database tables of the travel server. The database tables include, but are not limited to first subscription server encrypted profiles, second subscription server encrypted profiles, individual ticket parameters and associated real-time fee schedules, and links to security watch lists and/or government agencies.

In step S1280, a travel transaction agreement between the first subscription server and the second subscription server for the travel transaction is completed, via the travel server. The travel transaction agreement can include a confirmation that requirements of the purchase agreement and sales agreement have been met, security requirements have been met, and subscription terms are in agreement between the parties.

In step S1290, a travel transaction transfer s completed between the first subscription server and the second subscription server for the travel transaction, via the travel server. In one embodiment, an automatic transfer of a previously-established payment is made.

In one embodiment, the first subscription server differs from the second subscription server in travel subscription method 1200. A respective first kiosk and second kiosk also differ from one another. This embodiment could be implemented for a first user in a first location different from a second user in a second location.

In a second embodiment, the first subscription server is the same as the second subscription server. This embodiment could be implemented for a single location that is used by a plurality of subscribers. For example, the first subscription server can secure one or more travel subscription purchase agreements and one or more travel subscription sales agreements. Likewise, the second subscription server can secure one or more travel subscription purchase agreements and one or more travel subscription sales agreements.

In one embodiment, the travel server operates within a commercial airlines website and the travel transaction includes a non-refundable airline ticket. Likewise, the travel server can operate within a travel agency website and the travel transaction can include one or more of a non-refundable airline ticket, motel/hotel reservation, or rental vehicle reservation.

In one embodiment, the travel subscription sales agreement includes a real-time graduated fee schedule based upon an original purchase price of the travel transaction. Transaction parameters can include one or more of a ticket holder identity, travel itinerary, and financial arrangements.

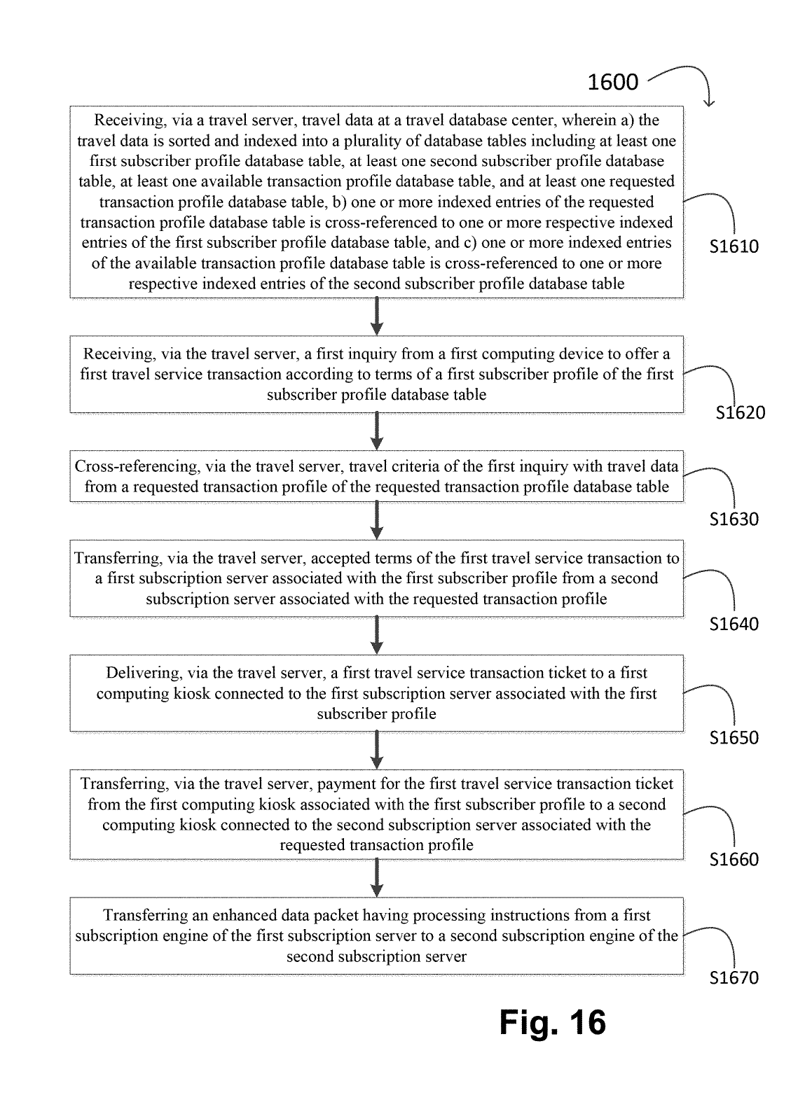

FIG. 16 is a flowchart for an exemplary travel subscription method 1600. Step S1610 includes receiving, via a travel server, travel data at a travel database center. The travel data is sorted and indexed into a plurality of database tables including at least one first subscriber profile database table, at least one second subscriber profile database table, at least one available transaction profile database table, and at least one requested transaction profile database table. One or more indexed entries of the requested transaction profile database table is cross-referenced to one or more respective indexed entries of the first subscriber profile database table. One or more indexed entries of the available transaction profile database table is cross-referenced to one or more respective indexed entries of the second subscriber profile database table.

Step S1620 includes receiving, via the travel server, a first inquiry from a first computing device to offer a first travel service transaction according to terms of a first subscriber profile of the first subscriber profile database table. The first travel service transaction can include an airline flight, a motel/hotel reservation, or a vehicle rental reservation.

Step S1630 includes cross-referencing, via the travel server, travel criteria of the first inquiry with travel data from a requested transaction profile of the requested transaction profile database table. For example, travel criteria of the first inquiry can include flight parameters, such as the desired dates and destination. The travel criteria of the first inquiry can be cross-referenced with a similar requested transaction profile database table.

Step S1640 includes transferring, via the travel server, accepted terms of the first travel service transaction to a first subscription server associated with the first subscriber profile from a second subscription server associated with the requested transaction profile. For example, accepted terms for a flight transaction can include the price of an associated airline ticket.

Step S1650 includes delivering, via the travel server, a first travel service transaction ticket to a first computing kiosk connected to the first subscription server associated with the first subscriber profile. The first travel service transaction ticket can include an airline ticket, a motel/hotel accommodation, or a vehicle rental accommodation.

Step S1660 includes transferring, via the travel server, payment for the first travel service transaction ticket from the first computing kiosk associated with the first subscriber profile to a second computing kiosk connected to the second subscription server associated with the requested transaction profile. Payment can be made according to terms of the first subscriber profile and the requested transaction profile.

Step S1670 includes transferring an enhanced data packet having processing instructions from a first subscription engine of the first subscription server to a second subscription engine of the second subscription server. In an embodiment, the enhanced data packet is transferred when demand for computing resources of the first subscription engine are above a predetermined threshold level.

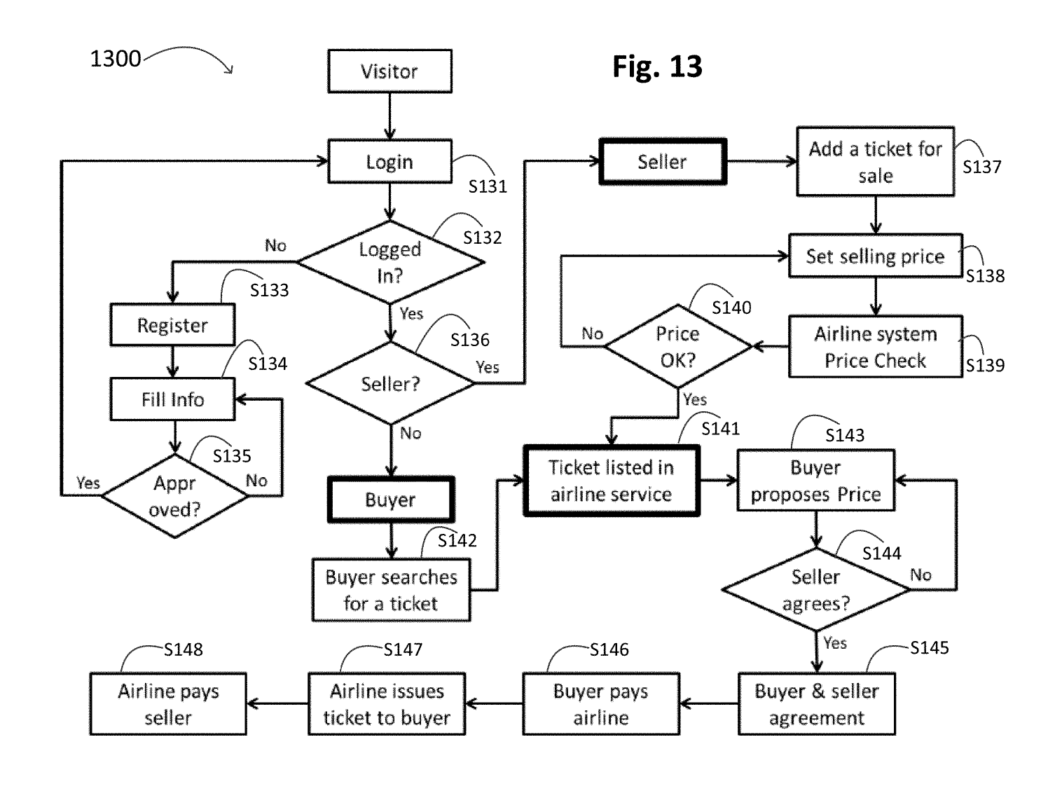

FIG. 13 is an exemplary algorithm 1300 for a travel service transaction of an airline ticket from a commercial airline company according to embodiments described herein. In exemplary algorithm 1300, the commercial airline company is the controlling entity for the travel service transaction. Stated another ray, the commercial airline company controls the travel server 150 in the travel service transfer system 100 during execution of exemplary algorithm 1300.

In exemplary algorithm 1300, a visitor or user initiates an action at the first server 150 or the second server 155, via a computing device 170 or a respective first kiosk 185 or second kiosk 190. In step S131, the user logs into the first server 150 or the second server 155.

In step S132, it is determined whether the user is a registered subscriber with a registered account. If the user is not a registered subscriber (“NO” in decision S132), the user is asked to register in step S133. Specific information is requested from the user in step S134. In one embodiment, all subscribers need to provide identification data correctly and accurately, which is verified and approved by the controlling entity.

In step S135, it is determined whether the information requested in step S134 for a registered subscriber account has been approved. For example, it is determined whether inputted information is complete, such as a complete mailing address. It can also be determined whether a user identification and password fulfill applicable security requirements. If the information is not accepted (“NO” in decision S135), additional information is requested from the user in step S134. If the information is accepted (“YES” in decision S135), the user is asked to login into the newly-established subscriber account in step S131.

When the registered subscriber successfully logs in at step S132 (“YES” in decision S132), it is determined whether the registered subscriber wishes to post one or more travel services for sale as a selling registered subscriber in step S136. For example, an inquiry can be displayed to the registered subscriber to select a particular action, such as post a travel service, search for a travel service, or complete a previously-saved travel service transaction. If the registered subscriber wishes to post one or more travel services for sale (“YES” in decision S136), an option is made to add an airline ticket for sale in step S137.

In step S138, a selling price of the airline ticket is set. In step S139, the commercial airline company checks the selling price set in step S138 to determine whether predetermined criteria have been met. For example, a maximum increase or a maximum decrease from the original sales price of the airline ticket may have been set by the commercial airline company.

In step S140, it is determined whether the set selling price from step S139 is acceptable. If the set selling price is not acceptable (“NO” in decision S140), the process returns to step S138 where a revised selling price is set. For example, if the previous set selling price in step S138 was over the maximum increase allowed by the commercial airline company, the user has an opportunity to adjust the set selling price to conform to the predetermined criteria. The revised set selling price is checked by the commercial airline company in step S139.

If the initial or revised set selling price is acceptable in step S140 (“YES” in decision S140), the airline ticket is listed in the commercial airline travel service in step S141. In one embodiment, the airline ticket is listed in an available travel service transaction profile database table 430.

When the registered subscriber does not wish to post one or more travel services for sale as a seller in step S136 (“NO” in step S136), it is determined that the registered subscriber wishes to acquire one or more available travel services as a buying registered subscriber. In step S142, the buying registered subscriber searches for an airline ticket that fits his/her travel criteria. In one embodiment, searches are made using one or more requested travel service transaction profiles 440. The search for the buying registered subscriber can include the one or more tickets listed by the selling registered subscriber in step S141.

In step S143, the buying registered subscriber proposes a price for a listed airline ticket. In step S144, it is determined whether the respective selling registered subscriber agrees with the proposed price. An exemplary graphical user interface will display fields requesting input from the buying registered subscriber, such as an offered price or any other predetermined criteria previously established by the respective selling registered subscriber.

If the selling registered subscriber does not agree with the proposed price as evidenced by an error message (“NO” in decision S144), a revised price is proposed by the buying registered subscriber in step S143. In an alternative embodiment, a revised price is not proposed by the buying registered subscriber in step S143, and the process ends.

If the selling registered subscriber agrees with the proposed price, as evidenced by an acceptance of the inputted information from the buying registered subscriber (“YES” in decision S144), the buying registered subscriber confirms acceptance of all terms of the transaction to form an agreement between the buying registered subscriber and the selling registered subscriber for purchase of the airline ticket in step S145. In step S146, the buying registered subscriber electronically pays the agreed-upon price and any other associated terms in step S146.

In step S147, the travel server 150 representing the commercial airline company issues an airline ticket to the buying registered subscriber. In step S148, the travel server 150 for the commercial airline company forwards payment for the airline ticket to the selling registered subscriber, via one of the first servers 150 or one of the second servers 155 at a respective first kiosk 185 or second kiosk 190 used by the selling registered subscriber.

One or more regulations can be established for embodiments described herein. For example, one or more airline ticket regulations can be established.

Precautionary measures can be established to avoid manipulating and generating a black market. For example, the list price of an airline ticket may not be higher than its original purchase price paid by the original ticket holder.

The airline ticket can be listed at a lower price than its original price along with specific terms. For example, the list price can be dynamically associated with time, such as a full listed price one week before departure of the flight, twenty percent lower than the list price at four days before the flight departure, and fifty percent lower than the list price at two days before departure of the flight. The dynamically-adjusted price can be associated with other terms according to the selling subscriber or the commercial airline company.

Selected offers and/or deadlines for the purchase or sale of an airline ticket can be established by the selling subscriber or the commercial airline company. The commercial airline company can adapt to local regulations, mechanisms, culture, and objectives of the individual local segments of the commercial airline company.

Security and confidentiality measures can be incorporated into the travel service transfer system 100. For example, neither a buying subscriber nor a selling subscriber can view information about an airline ticket that s associated with different personal data than the profile data of the respective buying subscriber or selling subscriber. Measures can also be incorporated to prevent posting or displaying an airline ticket after its flight departure time.

An airline ticket can be posted and sold as two or more separate flights when an original ticket includes one or more connecting flights. For example, an original ticket may include a flight from a departure city to a destination city with an intermediate city as a stopover between the departure city and the destination city. Therefore, the original ticket can be posted and sold as two separate flights, wherein the first posted flight is from the departure city to the intermediate city and the second posted flight is from the intermediate city to the destination city.

The travel service transfer system 100 can be made available to subscribing members only. Additional conditions can be established and agreed upon for non-subscribers.

Travel services provided by the travel service transfer system 100 can be implemented online through the Internet or a local intranet. Accommodations may not be available for paying in cash or for a face-to-face transaction encounter.

The travel service buying subscription or selling subscription could be a regular renewal service, such as an annual subscription service. Introductory periods or trial periods can be provided for a shorter period of subscription service time.

When a buying subscriber purchases an airline ticket, an option can be provided as to the reason for the flight, such as tourism, work, illness, or death. This information can be statistically correlated and used as a pre-selected list presented to future buying subscribers.

At the end of a travel service transaction, an option can be provided for a buying subscriber to rate one or more selling subscribers. Likewise, an option can be provided for a selling subscriber to rate an associated buying subscriber.

Various avenues can be implemented to provide revenue for the controlling entity. In addition to subscription fees for both the selling subscribers and the buying subscribers, revenue can be generated from a fee on every transaction. In addition, payment for a sale could be in the form of a travel voucher instead of money.

Embodiments described herein provide several technical advantages. Database tables are correlated and cross-referenced with other database tables in the travel database center 110. For example, a registered subscriber can have a buyer subscriber profile, as well as a seller subscriber profile. A large portion of the data will be the same for both subscriber profiles, such as personal information and financial information. Therefore, certain data fields from a first subscriber profile 410 can automatically populate similar data fields of a second subscriber profile 420. As a result, a more efficient and direct correlation can be made between subscribers posting available travel service transactions and prospective subscribers wishing to obtain one or more travel service transactions.

In another example, a registered subscriber may develop “favorite” buyer or seller transaction profiles and wish to have results with any applicable “favorite” transaction profiles returned first before other results. Therefore, data from a subscriber profile 410 or 420 could be cross-referenced to any “favorite” available transaction profiles 430 and/or any “favorite” requested transaction profiles 440. As a result, a more efficient and direct correlation can be made between subscribers searching for available travel service transactions and prospective subscribers wishing to resell existing travel service transactions.

Other technical advantages include the travel web portal 120 in which a plurality of entities are interconnected to provide a variety of travel service transactions. Subscribers from a plurality of entities representing available travel service transactions can be connected with subscribers from a plurality of entities representing requested travel service transactions. Entities from other facets of the travel industry, such as travel agencies and government agencies can also be interconnected. This provides a direct and secure exchange of travel service transactions that could not be transferred otherwise.

Other technical advantages include a network of servers, search engines, and kiosks in which to execute the direct and secure exchange of travel service transactions. A registered subscriber can initiate a search or posting of a travel service transaction using a first subscription server to another registered subscriber using a second subscription server.

In an embodiment, both ends of a transaction can be implemented with one of the first kiosks 185 associated with one of the first subscriber servers 150. Likewise, both ends of a transaction can be implemented with one of the second kiosks 190 associated with one of the second subscriber servers 155. This provides a direct and secure exchange of travel service transactions that could not be transferred otherwise.

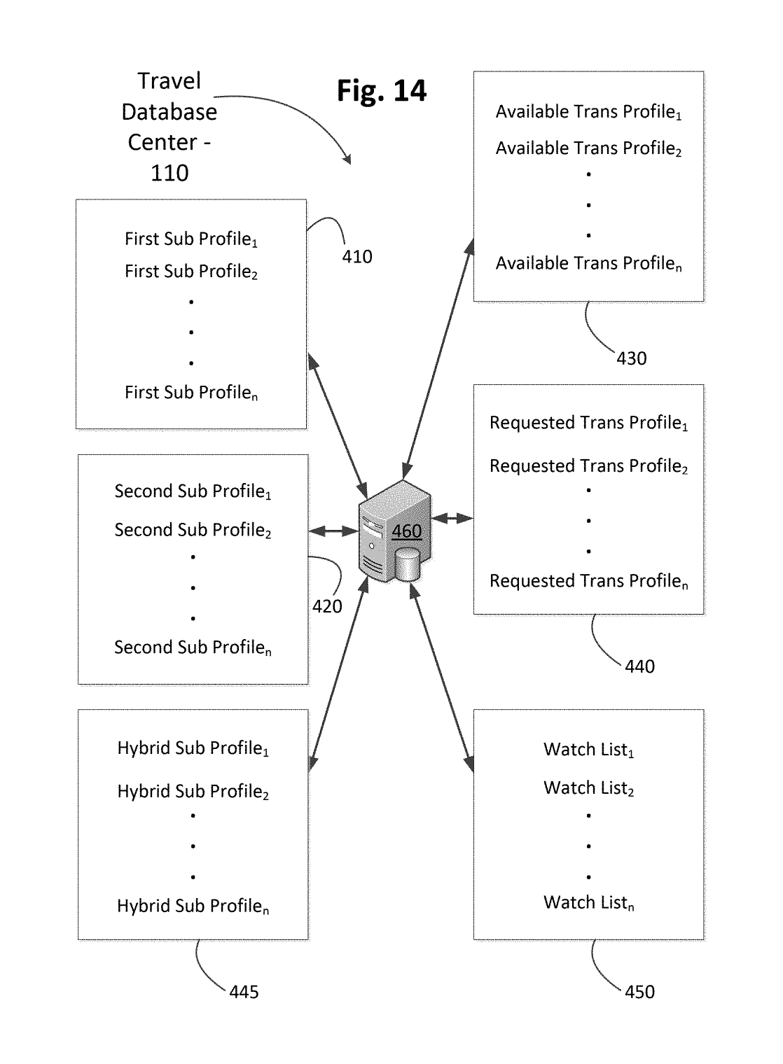

In another embodiment, a conditional travel service transaction can be established. FIG. 14 is a block diagram illustrating another embodiment of the travel database center 110. A database server 460 interconnects a plurality of first subscriber profiles 410, a plurality of second subscriber profiles 420, a plurality of available transaction profiles 430, a plurality of requested transaction profiles 440, and a plurality of watch lists 450, as previously illustrated in FIG. 4.

FIG. 14 also includes a plurality of hybrid subscriber profiles 445, which represents composite or complex subscriber profiles. For example, a registered subscriber may have a travel transaction, such as a first airline ticket listed as an available transaction profile 430, i.e. the registered subscriber has posted the first airline ticket for sale. In addition, the registered subscriber may wish to purchase a different travel transaction, such as a second airline ticket, which is contingent upon selling the first airline ticket. Therefore, a first hybrid subscriber profile 445 in this example contains both buyer data fields and seller data fields. In addition, the first hybrid subscriber profile 445 is cross-referenced to one or more available transaction profiles 430, as well as one or more requested transaction profiles 440. Whichever transaction occurs first can be saved in memory until the second transaction occurs. For example, if the registered subscriber agrees to acquire the second airline ticket first, that transaction is saved in memory until the registered subscriber sells the first airline ticket. Transfer of the two transactions occurs simultaneously, via the travel server 460. Likewise, the two travel transaction payments occur simultaneously, via the travel server 460.

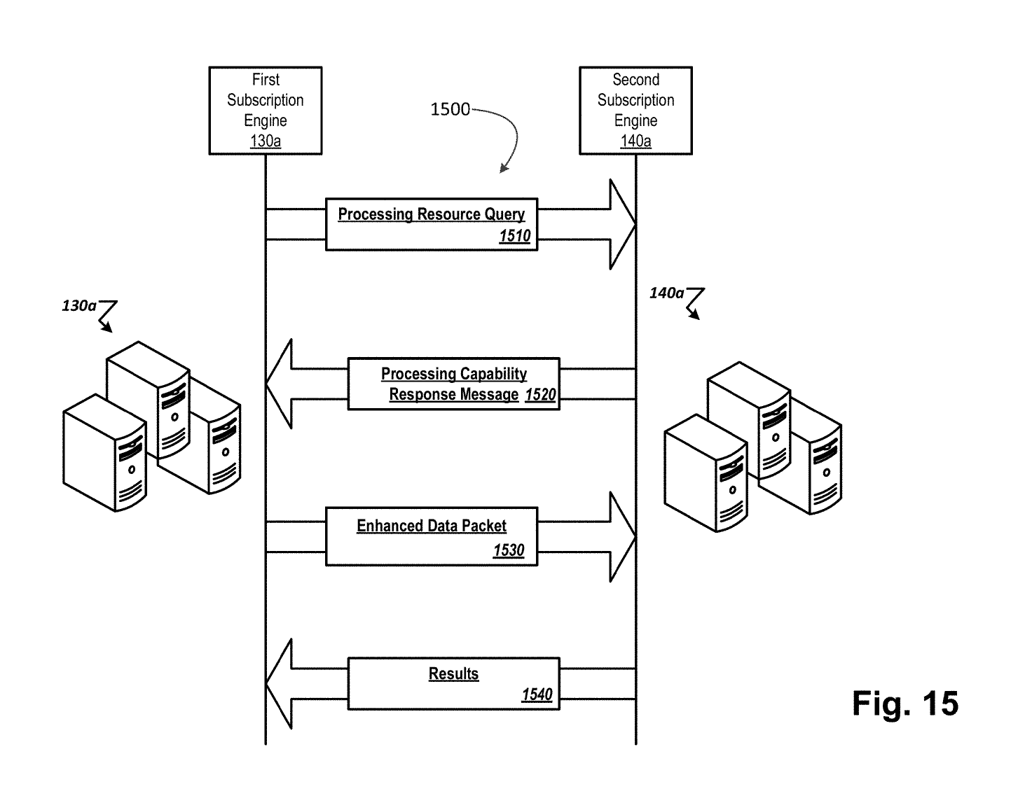

FIG. 15 is a block diagram illustrating an exemplary resource management system 1500, which includes computing resources of the first subscription engine 130a and the second subscription engine 140a. Either of the first subscription engine 130a or the second subscription engine 140a can be a single computing device or a hybrid network system of a plurality of computing devices.

In an embodiment, there may be an amount of network or processing congestion of computing resources in the first subscription engine 130a that is greater than a predetermined threshold. For example, there may be a great deal more requests to post available travel service transactions by first registered subscribers than to post requested travel service transactions by second registered subscribers. In order to more evenly distribute computing processing, the first subscription engine 130a sends a processing resource query 1510 to the second subscription engine 140a to process some of the received travel service transactions from the first registered subscribers.

In response to transmitting the processing resource query 1510 to the second subscription engine 140a, the first subscription engine 130a receives a processing capability response message 1520 from the second subscription engine 140a indicating its processing capabilities of its computing resources. Based on the processing capabilities of the second subscription engine 140a, the first subscription engine 130a allocates processing tasks to the second subscription engine 140a in order to reduce the processing burden on the first subscription engine 130a.

In another embodiment, a hybrid subscription engine of the hybrid subscription profiles 445 can also be considered for shared processing capabilities. In this embodiment, resource capabilities are obtained from both the second subscription engine 140a and the hybrid subscription engine. A selection is made by the first subscription engine 130a to use computing resources of either or both the second subscription engine 130a or the hybrid subscription engine. The selection can be made based upon which engine has the greatest processing capacity.

In response to selecting one of the engines such as the second subscription engine 140a, the first subscription engine 130a transmits an enhanced data packet 1530 to the second subscription engine 140a to perform the requested computing processes. For example, the enhanced data packet 1530 can include processing instructions for cross-referencing new first subscriber requests for posting available travel service transactions received at the first subscription engine 130a to associated requested transaction profiles 440.

By condensing the data associated with the request into a single data structure that is transmitted as an enhanced data packet, vast amounts of data are condensed, which reduces computer network congestion. In addition, other processing tasks associated with other processing engines of the travel service transfer system 100 can be similarly distributed to the second subscription engine 140a After the computing resources of the second subscription engine 140a has performed the processing tasks associated with the enhanced data packet 1520, the second subscription engine 140a transmits processing task results 1540 back to the first subscription engine 130a.

Embodiments described herein provide numerous advantages over conventional travel service transaction systems and methods. A controlling entity using the systems and methods described herein can provide a sophisticated service and earn a large customer loyalty pool. Travel can be organized online to reduce problems encountered in physical customer service areas and at airport lounges. A company's profit can be increased without relinquishing a large portion of the ticket value to the passenger. The rights of the controlling entity are maintained, which increases the profit through subscription fees for the travel service. Unoccupied booked seats can be made available, including seats for non-refundable airline tickets.

Advantages are provided to a selling subscriber by providing an upscale service while saving time and money. The full amount of a travel ticket can possibly be redeemed when there are no fees for sale of the travel ticket. Non-refundable tickets are made available instead of being wasted. In one embodiment, the only fees incurred are the subscription fees, which can offer unlimited opportunities for the frequent traveler.

Advantages are also provided to a buying subscriber. Offering a non-refundable ticket for resale can provide more opportunities in seat availability, especially for international flights. The buying subscriber is protected from being manipulated by high-priced tickets. The systems and methods described herein facilitate obtaining a travel ticket when an original travel ticket is not available directly from the source, which avoids a prolonged waiting period and at an affordable prices.

Embodiments described herein include the following aspects.

(1) A travel service transaction system having a first computing kiosk connected to a first subscription server, a second computing kiosk connected to a second subscription server, and a travel service transaction system server having processing circuitry. The processing circuitry is configured to receive travel data at a travel database center, wherein a) the travel data is sorted and indexed into a plurality of database tables including at least one first subscriber profile database table, at least one second subscriber profile database table, at least one available transaction profile database table, and at least one requested transaction profile database table, b) one or more indexed entries of the requested transaction profile database table is cross-referenced to one or more respective indexed entries of the first subscriber profile database table, and c) one or more indexed entries of the available transaction profile database table is cross-referenced to one or more respective indexed entries of the second subscriber profile database table. The processing circuitry is also configured to receive a first inquiry from a first computing device to offer a first travel service transaction according to terms of a first subscriber profile of the first subscriber profile database table, cross-reference travel criteria of the first inquiry with travel data from a requested transaction profile of the requested transaction profile database table, transfer accepted terms of the first travel service transaction to the first subscription server associated with the first subscriber profile from the second subscription server associated with the requested transaction profile, deliver a first travel service transaction ticket to the first computing kiosk associated with the first subscriber profile, transfer payment for the first travel service transaction ticket from the first computing kiosk associated with the first subscriber profile to the second computing kiosk associated with the requested transaction profile, and transfer an enhanced data packet having processing instructions from a first subscription engine of the first subscription server to a second subscription engine of the second subscription server.

(2) The travel service transaction system of (1), wherein the processing circuitry is further configured to receive a second inquiry from a second computing device to obtain a second travel service transaction according to terms of a second subscriber profile of the second subscriber profile database table, cross-reference travel criteria of the second inquiry with travel data from an available transaction profile of the available transaction profile database table, transfer accepted terms of the second travel service transaction to the second subscription server associated with the second subscriber profile from the first subscription server associated with the available transaction profile, deliver a second travel service transaction ticket to the second computing kiosk associated with the second subscriber profile, and transfer payment for the second travel service transaction ticket from the second computing kiosk associated with the second subscriber profile to the first computing kiosk associated with the available transaction profile.

(3) The travel service transaction system of either one of (1) or (2), wherein the travel database center includes at least one watch list database table of the travel database center.

(4) The travel service transaction system of any one of (1) through (3), wherein the processing circuitry is further configured to cross-reference the travel criteria of the first inquiry with travel data from the watch list database table.

(5) The travel service transaction system of any one of (1) through (4), wherein the enhanced data packet is transferred when demand for computing resources of the first subscription engine are above a predetermined threshold level.

(6) The travel service transaction system of any one of (1) through (5), wherein the travel database center includes a plurality of airline database tables, the first travel service transaction includes a first airline flight, the second travel service transaction includes a second airline flight, the first travel service transaction ticket includes a first airline ticket, and the second travel service transaction ticket includes a second airline ticket.

(7) The travel service transaction system of any one of (1) through (6), wherein the travel database center includes a plurality of motel/hotel database tables, the first travel service transaction includes a first motel/hotel reservation, the second travel service transaction includes a second motel/hotel reservation, the first travel service transaction ticket includes a first motel/hotel accommodation, and the second travel service transaction ticket includes a second motel/hotel accommodation.

(8) The travel service transaction system of any one of (1) through (7), wherein the travel database center includes a plurality of vehicle rental database tables, the first travel service transaction includes a first vehicle rental reservation, the second travel service transaction includes a second vehicle rental reservation, the first travel service transaction ticket includes a first vehicle rental accommodation, and the second travel service transaction ticket includes a second vehicle rental accommodation.

(9) The travel service transaction system of any one of (1) through (8), wherein the processing circuitry is further configured to secure a first travel subscription at the first subscription server, and secure a second travel subscription at the second subscription server.

(10) A non-transitory computer-readable medium having computer-executable instructions embodied thereon that when executed by a computing device, cause the computing device to perform a method. The method includes receiving travel data at a travel database center, wherein a) the travel data is sorted and indexed into a plurality of database tables including at least one first subscriber profile database table, at least one second subscriber profile database table, at least one available transaction profile database table, and at least one requested transaction profile database table, b) one or more indexed entries of the requested transaction profile database table is cross-referenced to one or more respective indexed entries of the first subscriber profile database table, and c) one or more indexed entries of the available transaction profile database table is cross-referenced to one or more respective indexed entries of the second subscriber profile database table. The method also includes receiving a first inquiry from a first computing device to offer a first travel service transaction according to terms of a first subscriber profile of the first subscriber profile database table, cross-referencing travel criteria of the first inquiry with travel data from a requested transaction profile of the requested transaction profile database table, transferring accepted terms of the first travel service transaction to a first subscription server associated with the first subscriber profile from a second subscription server associated with the requested transaction profile, delivering a first travel service transaction ticket to a first computing kiosk connected to the first subscription server associated with the first subscriber profile, transferring payment for the first travel service transaction ticket from the first computing kiosk associated with the first subscriber profile to a second computing kiosk connected to the second subscription server associated with the requested transaction profile, and transferring an enhanced data packet having processing instructions from a first subscription engine of the first subscription server to a second subscription engine of the second subscription server.

(11) The non-transitory computer-readable medium of (10), wherein the method further includes receiving a second inquiry from a second computing device to obtain a second travel service transaction according to terms of a second subscriber profile of the second subscriber profile database table, cross-referencing travel criteria of the second inquiry with travel data from an available transaction profile of the available transaction profile database table, transferring accepted terms of the second travel service transaction to the second subscription server associated with the second subscriber profile from the first subscription server associated with the available transaction profile, delivering a second travel service transaction ticket to the second computing kiosk associated with the second subscriber profile, and transferring payment for the second travel service transaction ticket from the second computing kiosk associated with the second subscriber profile to the first computing kiosk associated with the available transaction profile.

(12) A travel subscription method including receiving, via a travel server, travel data at a travel database center, wherein a) the travel data is sorted and indexed into a plurality of database tables including at least one first subscriber profile database table, at least one second subscriber profile database table, at least one available transaction profile database table, and at least one requested transaction profile database table, b) one or more indexed entries of the requested transaction profile database table is cross-referenced to one or more respective indexed entries of the first subscriber profile database table, and c) one or more indexed entries of the available transaction profile database table is cross-referenced to one or more respective indexed entries of the second subscriber profile database table. The travel subscription method also includes receiving, via the travel server, a first inquiry from a first computing device to offer a first travel service transaction according to terms of a first subscriber profile of the first subscriber profile database table; cross-referencing, via the travel server, travel criteria of the first inquiry with travel data from a requested transaction profile of the requested transaction profile database table; transferring, via the travel server, accepted terms of the first travel service transaction to a first subscription server associated with the first subscriber profile from a second subscription server associated with the requested transaction profile; delivering, via the travel server, a first travel service transaction ticket to a first computing kiosk connected to the first subscription server associated with the first subscriber profile; transferring, via the travel server, payment for the first travel service transaction ticket from the first computing kiosk associated with the first subscriber profile to a second computing kiosk connected to the second subscription server associated with the requested transaction profile; and transferring an enhanced data packet having processing instructions from a first subscription engine of the first subscription server to a second subscription engine of the second subscription server.

(13) The travel subscription method of (12), further including receiving, via the travel server, a second inquiry from a second computing device to obtain a second travel service transaction according to terms of a second subscriber profile of the second subscriber profile database table; cross-referencing, via the travel server, travel criteria of the second inquiry with travel data from an available transaction profile of the available transaction profile database table; transferring accepted tetras of the second travel service transaction to the second subscription server associated with the second subscriber profile from the first subscription server associated with the available transaction profile; delivering, via the travel server, a second travel service transaction ticket to the second computing kiosk associated with the second subscriber profile; and transferring, via the travel server, payment for the second travel service transaction ticket from the second computing kiosk associated with the second subscriber profile to the first computing kiosk associated with the available transaction profile.

(14) The travel subscription method of either one of (12) or (13), further including securing, via the travel server, a first travel subscription with the first subscription server; and securing, via the travel server, a second travel subscription with the second subscription server.

(15) The travel subscription method of any one of (12) through (14), further including contracting with the second subscription server terms for transfer of the first travel service transaction; and configuring via the travel server, transfer details of the first travel service transaction.

(16) The travel subscription method of any one of (12) through (15), wherein the enhanced data packet is transferred when demand for computing resources of the first subscription engine are above a predetermined threshold level.

(17) The travel subscription method of any one of (12) through (16), further including cross-referencing the travel criteria of the first inquiry and the second inquiry with travel data from a watch list database table of the travel database center.

(18) The travel subscription method of any one of (12) through (17), wherein the travel database center includes a plurality of airline database tables, the first travel service transaction includes a first airline flight, the second travel service transaction includes a second airline flight, the first travel service transaction ticket includes a first airline ticket, and the second travel service transaction ticket includes a second airline ticket.

(19) The travel subscription method of any one of (12) through (18), wherein the travel database center includes a plurality of motel/hotel database tables, the first travel service transaction includes a first motel/hotel reservation, the second travel service transaction includes a second motel/hotel reservation, the first travel service transaction ticket includes a first motel/hotel accommodation, and the second travel service transaction ticket includes a second motel/hotel accommodation.

(20) The travel subscription method of any one of (12) through (19), wherein the travel database center includes a plurality of vehicle rental database tables, the first travel service transaction includes a first vehicle rental reservation, the second travel service transaction includes a second vehicle rental reservation, the first travel service transaction ticket includes a first vehicle rental accommodation, and the second travel service transaction ticket includes a second vehicle rental accommodation.

A number of implementations have been described. Nevertheless, it ill be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes, and algorithms described herein may be performed in hardware or software executed by hardware, including computer processors and/or programmable circuits configured to execute program code and/or computer instructions to execute the functions, processes, and algorithms described herein. Additionally, an implementation may be performed on modules or hardware not identical to those described. Accordingly, other implementations are within the scope that may be claimed.

The foregoing discussion describes merely exemplary embodiments of the present disclosure. As will be understood by those skilled in the art, the present disclosure may be embodied in other specific forms without departing from the spirit or essential characteristics thereof. Accordingly, the disclosure is intended to be illustrative, but not limiting of the scope of the disclosure, as well as the claims. The disclosure, including any readily discernible variants of the teachings herein, defines in part, the scope of the foregoing claim terminology such that no inventive subject matter is dedicated to the public.

1. A travel service transaction system, comprising:
a first computing kiosk connected to a first subscription server;
a second computing kiosk connected to a second subscription server; and
a travel service transaction system server having processing circuitry configured to
receive travel data at a travel database center, wherein a) the travel data is sorted and indexed into a plurality of database tables including at least one first subscriber profile database table, at least one second subscriber profile database table, at least one available transaction profile database table, and at least one requested transaction profile database table, b) one or more indexed entries of the requested transaction profile database table is cross-referenced to one or more respective indexed entries of the first subscriber profile database table, and c) one or more indexed entries of the available transaction profile database table is cross-referenced to one or more respective indexed entries of the second subscriber profile database table,
receive a first inquiry from a first computing device to offer a first travel service transaction according to terms of a first subscriber profile of the first subscriber profile database table,
cross-reference travel criteria of the first inquiry with travel data from a requested transaction profile of the requested transaction profile database table,
transfer accepted terms of the first travel service transaction to the first subscription server associated with the first subscriber profile from the second subscription server associated with the requested transaction profile,
deliver a first travel service transaction ticket to the first computing kiosk associated with the first subscriber profile,
transfer payment for the first travel service transaction ticket from the first computing kiosk associated with the first subscriber profile to the second computing kiosk associated with the requested transaction profile, and
transfer an enhanced data packet having processing instructions from a first subscription engine of the first subscription server to a second subscription engine of the second subscription server.

2. The travel service transaction system of claim 1, wherein the processing circuitry is further configured to
receive a second inquiry from a second computing device to obtain a second travel service transaction according to terms of a second subscriber profile of the second subscriber profile database table,
cross-reference travel criteria of the second inquiry with travel data from an available transaction profile of the available transaction profile database table,
transfer accepted terms of the second travel service transaction to the second subscription server associated with the second subscriber profile from the first subscription server associated with the available transaction profile,
deliver a second travel service transaction ticket to the second computing kiosk associated with the second subscriber profile, and
transfer payment for the second travel service transaction ticket from the second computing kiosk associated with the second subscriber profile to the first computing kiosk associated with the available transaction profile.

3. The travel service transaction system of claim 2, wherein the travel database center includes at least one watch list database table of the travel database center.

4. The travel service transaction system of claim 3, wherein the processing circuitry is further configured to cross-reference the travel criteria of the first inquiry with travel data from the watch list database table.

5. The travel service transaction system of claim 1, wherein the enhanced data packet is transferred when demand for computing resources of the first subscription engine are above a predetermined threshold level.

6. The travel service transaction system of claim 1, wherein
the travel database center includes a plurality of airline database tables,
the first travel service transaction includes a first airline flight,
the second travel service transaction includes a second airline flight,
the first travel service transaction ticket includes a first airline ticket, and
the second travel service transaction ticket includes a second airline ticket.

7. The travel service transaction system of claim 1, wherein
the travel database center includes a plurality of motel/hotel database tables,
the first travel service transaction includes a first motel/hotel reservation,
the second travel service transaction includes a second motel/hotel reservation,
the first travel service transaction ticket includes a first motel/hotel accommodation, and
the second travel service transaction ticket includes a second motel/hotel accommodation.

8. The travel service transaction system of claim 1, wherein
the travel database center includes a plurality of vehicle rental database tables,
the first travel service transaction includes a first vehicle rental reservation,
the second travel service transaction includes a second vehicle rental reservation,
the first travel service transaction ticket includes a first vehicle rental accommodation, and
the second travel service transaction ticket includes a second vehicle rental accommodation.

9. The travel service transaction system of claim 1, wherein the processing circuitry is further configured to
secure a first travel subscription at the first subscription server, and
secure a second travel subscription at the second subscription server.

10. A non-transitory computer-readable medium having computer-executable instructions embodied thereon that when executed by a computing device, cause the computing device to perform a method, the method comprising:
receiving travel data at a travel database center, wherein a) the travel data is sorted and indexed into a plurality of database tables including at least one first subscriber profile database table, at least one second subscriber profile database table, at least one available transaction profile database table, and at least one requested transaction profile database table, b) one or more indexed entries of the requested transaction profile database table is cross-referenced to one or more respective indexed entries of the first subscriber profile database table, and c) one or more indexed entries of the available transaction profile database table is cross-referenced to one or more respective indexed entries of the second subscriber profile database table;
receiving a first inquiry from a first computing device to offer a first travel service transaction according to terms of a first subscriber profile of the first subscriber profile database table;
cross-referencing travel criteria of the first inquiry with travel data from a requested transaction profile of the requested transaction profile database table;
transferring accepted terms of the first travel service transaction to a first subscription server associated with the first subscriber profile from a second subscription server associated with the requested transaction profile;
delivering a first travel service transaction ticket to a first computing kiosk connected to the first subscription server associated with the first subscriber profile;
transferring payment for the first travel service transaction ticket from the first computing kiosk associated with the first subscriber profile to a second computing kiosk connected to the second subscription server associated with the requested transaction profile; and
transferring an enhanced data packet having processing instructions from a first subscription engine of the first subscription server to a second subscription engine of the second subscription server.

11. The non-transitory computer-readable medium of claim 10, wherein the method further comprises:
receiving a second inquiry from a second computing device to obtain a second travel service transaction according to terms of a second subscriber profile of the second subscriber profile database table;
cross-referencing travel criteria of the second inquiry with travel data from an available transaction profile of the available transaction profile database table;
transferring accepted terms of the second travel service transaction to the second subscription server associated with the second subscriber profile from the first subscription server associated with the available transaction profile;
delivering a second travel service transaction ticket to the second computing kiosk associated with the second subscriber profile; and
transferring payment for the second travel service transaction ticket from the second computing kiosk associated with the second subscriber profile to the first computing kiosk associated with the available transaction profile.

12. A travel subscription method, comprising:
receiving, via a travel server, travel data at a travel database center, wherein a) the travel data is sorted and indexed into a plurality of database tables including at least one first subscriber profile database table, at least one second subscriber profile database table, at least one available transaction profile database table, and at least one requested transaction profile database table, b) one or more indexed entries of the requested transaction profile database table is cross-referenced to one or more respective indexed entries of the first subscriber profile database table, and c) one or more indexed entries of the available transaction profile database table is cross-referenced to one or more respective indexed entries of the second subscriber profile database table;
receiving, via the travel server, a first inquiry from a first computing device to offer a first travel service transaction according to terms of a first subscriber profile of the first subscriber profile database table;
cross-referencing, via the travel server, travel criteria of the first inquiry with travel data from a requested transaction profile of the requested transaction profile database table;
transferring, via the travel server, accepted terms of the first travel service transaction to a first subscription server associated with the first subscriber profile from a second subscription server associated with the requested transaction profile;
delivering, via the travel server, a first travel service transaction ticket to a first computing kiosk connected to the first subscription server associated with the first subscriber profile;
transferring, via the travel server, payment for the first travel service transaction ticket from the first computing kiosk associated with the first subscriber profile to a second computing kiosk connected to the second subscription server associated with the requested transaction profile; and
transferring an enhanced data packet having processing instructions from a first subscription engine of the first subscription server to a second subscription engine of the second subscription server.

13. The travel subscription method of claim 12, further comprising:
receiving, via the travel server, a second inquiry from a second computing device to obtain a second travel service transaction according to terms of a second subscriber profile of the second subscriber profile database table;
cross-referencing, via the travel server, travel criteria of the second inquiry with travel data from an available transaction profile of the available transaction profile database table;
transferring accepted terms of the second travel service transaction to the second subscription server associated with the second subscriber profile from the first subscription server associated with the available transaction profile;
delivering, via the travel server, a second travel service transaction ticket to the second computing kiosk associated with the second subscriber profile; and
transferring, via the travel server, payment for the second travel service transaction ticket from the second computing kiosk associated with the second subscriber profile to the first computing kiosk associated with the available transaction profile.

14. The travel subscription method of claim 13, further comprising:
securing, via the travel server, a first travel subscription with the first subscription server; and
securing, via the travel server, a second travel subscription with the second subscription server.

15. The travel subscription method of claim 14, further comprising:
contracting with the second subscription server terms for transfer of the first travel service transaction; and
confirming, via the travel server, transfer details of the first travel service transaction.

16. The travel subscription method of claim 12, wherein the enhanced data packet is transferred when demand for computing resources of the first subscription engine are above a predetermined threshold level.

17. The travel subscription method of claim 13, further comprising:
cross-referencing the travel criteria of the first inquiry and the second inquiry with travel data from a watch list database table of the travel database center.

18. The travel subscription method of claim 13, wherein
the travel database center includes a plurality of airline database tables,
the first travel service transaction includes a first airline flight,
the second travel service transaction includes a second airline flight,
the first travel service transaction ticket includes a first airline ticket, and
the second travel service transaction ticket includes a second airline ticket.

19. The travel subscription method of claim 13, wherein
the travel database center includes a plurality of motel/hotel database tables,
the first travel service transaction includes a first motel/hotel reservation,
the second travel service transaction includes a second motel/hotel reservation,
the first travel service transaction ticket includes a first motel/hotel accommodation, and
the second travel service transaction ticket includes a second motel/hotel accommodation.

20. The travel subscription method of claim 13, wherein
the travel database center includes a plurality of vehicle rental database tables,
the first travel service transaction includes a first vehicle rental reservation,
the second travel service transaction includes a second vehicle rental reservation,
the first travel service transaction ticket includes a first vehicle rental accommodation, and
the second travel service transaction ticket includes a second vehicle rental accommodation.
